(19) United States
(12) Patent Application Publication
(10) Pub. No.: US 2015/0175877 A1
(43) Pub. Date: Jun. 25, 2015

(54) ENVIRONMENTALLY ACCEPTABLE MULTIFUNCTIONAL ADDITIVE

(71) Applicant: SCHLUMBERGER TECHNOLOGY CORPORATION, Sugar Land, TX (US)

(72) Inventors: Nikhil Dilip Shindgikar, Aberdeen (GB); Carlos Abad, Aberdeen (GB); Mark Williams, Aberdeen (GB)

(21) Appl. No.: 14/573,262

(22) Filed: Dec. 17, 2014

Related U.S. Application Data
(60) Provisional application No. 61/918,301, filed on Dec. 19, 2013.

(51) Int. Cl. C09K 8/60; C09K 8/68

(52) U.S. Cl. CPC C09K 8/605; C09K 8/68; C09K 8/685; C09K 2208/26

(57) ABSTRACT

A method of treating a subterranean formation penetrated by a wellbore, the method including the introduction a treatment fluid comprising an aqueous fluid composition comprising an aldehyde releasing compound.

### CROSS REFERENCE TO RELATED APPLICATION(S)

This application claims the benefit of U.S. Provisional Application Ser. No. 61/918,301 filed Dec. 19, 2013 entitled “Environmentally Acceptable Multifunctional Additive” to Shindgikar et al. (Attorney Docket No. IS13.4434-US-PSP), the disclosure of the provisional application is incorporated by reference herein in its entirety.

### BACKGROUND

Hydrocarbons (oil, natural gas, etc.) are obtained from subterranean geologic formations (“reservoirs”) by drilling wells that penetrate the hydrocarbon-bearing formations. In the process of recovering hydrocarbons from subterranean formations, it is common practice to treat a hydrocarbon-bearing formation with a pressurized fluid to provide enhanced flow path and or channels, i.e., to fracture the formation, and or to use such fluids to transport and place proppant to facilitate flow of the hydrocarbons to the wellbore.

Oilfield operations containing well treatment fluids may be employed in either a land or offshore environment, with the offshore environment receiving recent attention from an environmental perspective in various regions of the globe (North and South America, Continental Europe, Oceania, or West Africa). One offshore environment in particular, the North Sea, has had for the last 30 years or so some of the most stringent environmental and discharge regulations in the world. Therefore, the regulations, parameters, criteria and test methods used to evaluate environmental compliance in the North Sea can and are being employed as benchmarks for environmental compliance in other geographic locations.

Any oilfield chemical that is used in the North Sea is registered with the respective country's regulatory body and that regulatory body assigns a rating or color classification to each chemical depending on its environmental and toxicological characteristics. Based on the chemical rating or color classification, the chemical will either be regarded as more or less environmentally friendly or unfriendly. In the North Sea, the classification techniques vary. For example, (1) Norway and Denmark follow color classification for chemical products, (2) United Kingdom (UK) follows color and letter ratings for organic and inorganic chemical products respectively and (3) Netherlands follows letter categories. In other words, even countries within a small geographic region have customized their classification system based upon a desire to differentiate environmentally friendly and unfriendly chemical products. Regardless of the classification system, each of the North Sea countries (Norway, Denmark, Netherlands and United Kingdom) employs the same three ecotoxicology tests criteria to determine whether a specific chemical may be classified as environmentally friendly. These three ecotoxicology tests describe whether a chemical product features, on a component level, (1) ≧60% biodegradation in seawater after 28 days, (2) little to no bioaccumulation potential among aquatic life (less than 3 partition coefficient (log Pow)) and (3) little to no-toxicity towards aquatic life (less than 10 mg/L). For convenience, the North Sea regulations are summarized below in Table 1.

TABLE 1
North Sea Regulations Interpretation*

| Test | Biodegradation | | | Bioaccumulation | | Toxicity - EC/LC50 | |
|---|---|---|---|---|---|---|---|
| Unit | % | | | Log Pow | | mg/L | |
| Result | <20 | 20-60 | >60 | <3 | >3 | <10 | >10 |
| Inference | Very | Bad | Good | Good | Bad | Bad | Good |
| | bad | | | | | | |

*As a rule of thumb, two or more “Good” results means that the compounds is acceptable, while two or more “Bad” results means that the compound is unacceptable. However, a compound having less than 20% biodegradation alone also means that the compound is unacceptable.

When each component in a chemical product passes the above-mentioned criteria, then the whole product is rated as Green or PLONOR (Pose Little Or NO Risk) in Norway and Denmark. When one of the components only meets two of the criteria, then the product can still receive ‘Yellow’ classification in Norway and Denmark, but still environmentally friendly. If the biodegradation in seawater is <20% after 28 days for any of the component, then the chemical products gets ‘red’ color classification or substitution warning (i.e., an environmentally unfriendly classification in the North Sea).

Depending on the service performed, a well service operation may require a large amount of chemicals, which means that the introduction of environmentally friendly chemicals is mandatory. One unique situation is the introduction of environmentally friendly biocide chemicals to the North Sea. Since any chemical with biocidal activity may never meet the toxicity criteria of the North Sea regulations, any “environmentally friendly” biocide will need to meet the biodegradation and bioaccumulation criteria to be able to be classified as environmentally friendly and acceptable.

Offshore well treatment operations sometimes require as much as simplicity as possible and this includes using a minimal number of chemical additives to form simplified, lower environmental risk treatment fluids, and this includes the use of multifunctional additives when possible. In such an environment, a multifunctional additive capable of performing various tasks in a fluid at different times or temperatures of use may become a great advantage.

Well treatment fluids, particularly those used in fracturing (fracturing fluids), may comprise a water or oil-based fluid incorporating a thickening agent, normally a polymeric material. Polymeric thickening agents for use in such fluids may comprise galactomannan gums, such as guar and substituted guars such as hydroxypropyl guar and carboxymethylhydroxypropyl guar (CMHPG). Cellulosic polymers such as carboxymethyl cellulose may also be used, as well as synthetic polymers such as polyacrylamide, and its copolymers and derivatives. Such fracturing fluids can have a high viscosity during a treatment to develop the desired fracture geometry and/or to carry proppant into a formation with sufficient resistance to settling. Biocides have been employed as oilfield chemicals, during the hydration of gelling polymers, such as guar in water, since this is a process that can be impaired by the presence of bacteria. The use of biocides can prevent the undesirable growth of sulfur reducing bacteria (SRBs) at downhole temperatures in the reservoir, which are known to produce hydrogen sulfide (H2S), and sour the reservoirs, as well as extend the lifetime of a formulated fluid at surface conditions by preventing bacterial growth and fluid degradation or viscosity break, which may be important in off-shore treatments. In these type of treatments, the polymer fluid solution (also known as linear fluid) may be batch mixed (polymer dissolved in water) in preparation for a treatment. At times, due to unforeseen reasons (rig or well derived, or weather derived) the downhole treatment might need to be delayed for a considerable length of time. In these cases, the use of an effective environmentally friendly biocide which lengthens the working shelf life of the linear fluid becomes of high importance. Moreover, should the off-shore treatments be formulated with seawater or fresh water, the well intervention operation might be subsequently followed by seawater injection assisted production. Seawater contains a substantially higher amount of bacteria than a treated urban water source, making the biocide a very much required component of the treatments. It is generally accepted that biocides do not affect the polymer stability at high temperature.

It is generally understood as well that properly formulated breaker chemicals and systems do not substantially affect the ambient temperature stability of a polymer based aqueous fluid. It is also not expected that a breaker would substantially improve the fluid preservation at room temperature. If any effect is observed, since all oxidative breakers retain some activity at room temperature, it could be expected that in the long term the main effect derived of a breaker at ambient temperature could be a minor viscosity decrease of the fluid. It is at elevated temperatures that breakers will be generally affecting fluid rheology, causing the desired control drop in fluid viscosity they are designed to achieve.

The recovery of the fracturing fluid is achieved by reducing the viscosity of the fluid such that the fluid flows naturally through the proppant pack. Chemical reagents, such as oxidizers, chelants, acids and enzymes may be employed to break the polymer networks to reduce their viscosity. These materials are commonly referred to as “breakers” or “breaking agents.”

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some embodiments, the present disclosure relates to an environmentally friendly multifunctional well treatment additive comprising at least an aldehyde releasing compound that has the capability to at least function as a biocide and a breaker, while also maintaining a favorable environmental rating in the North Sea. More specifically, the present disclosure relates to a method of treating a subterranean formation penetrated by a wellbore, the method comprising: introducing a treatment fluid comprising an aqueous fluid composition comprising an aldehyde releasing compound, wherein the aldehyde releasing compound: reduces a plurality of bacteria in the treatment fluid to be less than 1×10³ colony-forming units (CFU) at a temperature range of from about −10° C. to about 60° C. and reduces the viscosity of a viscosified treatment fluid by at least one order of magnitude while the viscosified treatment fluid is at a temperature in the range of from about 79.4° C. (175° F.) to about 232.2° C. (450° F.).

### BRIEF DESCRIPTION OF DRAWINGS

FIG. 1 shows a plot of the viscosity over time according to one or more of the embodiments described herein.

FIG. 2 shows a plot of the viscosity over time according to one or more of the embodiments described herein.

FIG. 3 shows a plot of the viscosity over time according to one or more of the embodiments described herein.

FIG. 4 shows a plot of the viscosity over time according to one or more of the embodiments described herein.

FIG. 5 shows a plot of the viscosity over time according to one or more of the embodiments described herein.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range

The present disclosure is generally directed toward an environmentally friendly multifunctional well treatment additive comprising at least an aldehyde releasing compound that has the capability to at least function as a biocide and a breaker, while also maintaining a favorable environmental rating in the North Sea. In particular, environmentally friendly multifunctional additives that function as biocides at low temperatures and as breakers at high temperatures are presented. As used herein the phrase “low temperatures” refers to temperatures which the fluid will be exposed to during formulation and surface pumping operations, such as, for example, temperatures from about −10° C. to about 60° C., from about −5° C. to about 50° C., and from about 0° C. to about 45° C. As used herein the phrase “high temperatures” refers to temperatures which the fluid will be exposed downhole while contacting the reservoir, such as, for example, from about 30° C. to about 250° C., from about 40° C. to about 240° C., and from about 50° C. and 230° C.

As used herein, the term “environmentally friendly” is defined as chemicals or formulations that can pass the most stringent environmental testing criteria. Furthermore, as used herein, the term “environmentally unfriendly” is defined as chemicals or formulations that do not pass the most stringent environmental testing criteria. At present, the geographic location with the most stringent environmental testing criteria for well treatment operation is the North Sea, but the definition of either of these terms should in no way be limited to any past, present or future North Sea environmental testing criteria.

The term “treatment”, or “treating”, refers to any subterranean operation that uses a fluid in conjunction with a desired function and/or for a desired purpose. The term “treatment”, or “treating”, does not imply any particular action by the fluid.

The term “horizontal wellbore” refers to wells that are substantially drilled through a subterranean zone to maximize the exposure to the zone. For zones which are primarily horizontal, the wellbore may have a deviation from the vertical of 80 to 110 degrees in the productive zone of interest. For those zones that have an inclination from the horizontal, the wellbore will primarily be drilled at an angle to keep the wellbore within the zone. Horizontal wellbores are typically vertical near the surface and incline to a direction substantially parallel to the bedding planes of the zone into which the wellbore is placed. Often in shale reservoirs and low permeability formations, multiple hydraulic fractures are placed along the length of this wellbore to maximize contact between the formation and the wellbore. Fractures are normally done starting at the toe of the well and suitable means are employed to isolate those fractures before the next fracture is performed. When all fracturing is complete, the isolation mechanism (often referred to as zonal isolation“) is removed and all the fractured zones are in hydraulic communication with the wellbore and the surface. Zonal isolation systems are used to isolate and selectively produce oil or gas from separate zones in a single well, which are described in detail in U.S. Pat. Nos. 5,579,844; 5,609,204 and 5,988,285, the disclosures of which are incorporated by reference herein in their entirety. For the extended time to fully complete the well with multiple fractures, the first fractures may be shut-in for several days to several weeks, which provide an environment for microbes to flourish if biocides are not included in the treatment fluid. Traditional biocides do not always have the capability to provide protection for extended time needed in these wells.

The term “fracturing” refers to the process and methods of breaking down a geological formation and creating a fracture, i.e., the rock formation around a wellbore, by pumping fluid at a very high pressure (pressure above the determined closure pressure of the formation), in order to increase production rates from or injection rates into a hydrocarbon reservoir. The fracturing methods otherwise use conventional techniques known in the art.

A “crosslinker” or “crosslinking agent” is a compound mixed with a base-gel fluid to create a viscous gel. Under proper conditions, the crosslinker reacts with a water soluble polymer to couple the molecules, creating a crosslinked polymer fluid of high, but closely controlled viscosity.

A “fracturing fluid” is often described as a linear gel, a crosslinked gel a viscoelastic surfactant gel, an emulsion or a foamed fluid, or a slickwater. Linear and crosslinked gels typically contain 1.2 to 7.2 kg/cubic meter (10 to 60 pounds per thousand gallons) of a biopolymer such as guar or a derivatized guar, or a synthetic polymer such a polyacrylamide, or a polyacrylamide derivative such as partially hydrolyzed polyacrylamide, acrylamide-co acrylic acid copolymers, acrylamide-AMPS -co acrylic acid terpolymers, and the like. Crosslinked fluids have higher viscosity from the effect of the crosslinker. Viscoelastic surfactant systems are characterized by developing viscosity by means of the entanglements on substantially elongated micellar systems (worm like micelles) derived from some specific clases of surfactants. Emulsions and foams are characterized by the presence of a separate immiscible phase in addition to the aqueous viscosified fluid, oil for emulsions and gas for foams. Slickwater is characterized as a water containing small amounts of a drag reducing agent such as polyacrylamide, a micellar solution of viscoelastic surfactants, or a low concentration linear gel which reduces friction by 40 to 80% over that experienced without the drag reducer. This allows the treatment to be pumped at higher rate or lower pressure. Various other additives comprise the fracturing fluid including biocides, scale inhibitors, surfactants, additional breakers (besides those mentioned above), breaker aids, oxygen scavengers, alcohols, corrosion inhibitors, fluid-loss additives, fibers, proppant flow back additives, thermal stabilizers, proppants and the like.

The term “hydraulic fracturing” as used in the present application refers to a technique that involves pumping fluids into a well at pressures and flow rates high enough to split the rock and create opposing cracks extending up to 300 m (1000 feet) or more from either side of the borehole. Later, sand or ceramic particulates, called “proppant,” are carried by the fluid to pack the fracture, keeping it open once pumping stops and pressures decline. Complex fractures which include secondary and tertiary fractures connecting to the main fracture can also result from fracturing operations and are dependent upon the formation properties.

As used herein, the new numbering scheme for the Periodic Table Groups are used as in Chemical and Engineering News, 63(5), 27 (1985).

As used herein, the term “liquid composition” or “liquid medium” refers to a material which is liquid under the conditions of use. For example, a liquid medium may refer to water, and/or an organic solvent which is above the freezing point and below the boiling point of the material at a particular pressure. A liquid medium may also refer to a supercritical fluid.

As used herein, the term “polymer” or “oligomer” is used interchangeably unless otherwise specified, and both refer to homopolymers, copolymers, interpolymers, terpolymers, and the like. Likewise, a copolymer may refer to a polymer comprising at least two monomers, optionally with other monomers. When a polymer is referred to as comprising a monomer, the monomer is present in the polymer in the polymerized form of the monomer or in the derivative form of the monomer. However, for ease of reference the phrase comprising the (respective) monomer or the like is used as shorthand.

As used herein, the term “biocide” refers to agents such as germicides, bactericides, disinfectants, sterilizers, preservatives, fungicides, algicides, aquaticides, herbicides, insecticides, larvicides, pesticides, plant growth regulators and the like, each of which may be used for their ability to inhibit growth of and/or destroy various biological and/or microbiological species such as bacteria, fungi, algae, insects, larvae, worms and the like.

As used herein, the term “breaker” refers to agents such as oxidizers, redox agents, metals, enzymes, and the like which may be used to reduce the fluid viscosity at a predefined temperature and time within the treatment timeframe.

In embodiments, the multifunctional well treatment additive may be an aldehyde releasing compound. In accordance with the presently claimed subject matter, an “aldehyde-releasing compound” refers to a molecule or compound which is capable of releasing at least one, one, two, three of four-aldehyde containing compounds. Also, an “aldehyde-releasing compound” refers to a compound which is capable of releasing more than four aldehyde containing compounds. Some examples of these compounds are described in U.S. Pat. No. 8,568,754 and U.S. Patent Application Pub. Nos. 2013/0096167, 2013/0123369 and 2004/082473, the disclosures of which are incorporated by reference herein in their entirety.

In the foregoing, when describing molecular structures, it will be understood that in the case of polymeric or oligomeric structures or polymer or oligomer containing structures, a single molecular structure may not perfectly describe the chemical in question, since different molecules considered to pertain to the same chemical compound may have different degrees of polymerization. For each individual single molecule the degree of polymerization is defined as an integer number, which corresponds to the number of times a particular structure is repeated. Polymeric or polymer containing chemical products are necessarily mixtures of molecules with different degrees of polymerization, and thus it is understood that while individual molecules will be characterized by integer degree of polymerization values, commercially available products may be found with non integer degrees of polymerization. When describing possible structures for the multifunctional well treatment additive disclosed herein, integer values of degree of polymerization will be discussed for specific molecules, but this does not preclude that mixtures of molecules having different degrees of polymerization are considered to pertain to the same structure, and therefore the overall or average degree of polymerization may be a non-integer number.

What is disclosed refers to aldehyde releasing chemical compounds with low temperature biocidal activity and high temperature breaker activity and a favorable environmental profile described by the generic molecular structure 1A.

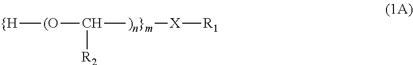

where R₁ is a functional hydrocarbon comprising one or more of Carbon (C), Hydrogen (H), possibly Nitrogen (N) Oxygen (O) Chlorine (Cl), Bromine (Br), Phosphorous (P), Sulfur (S), Fluorine (F) or combinations thereof, or which is linked to a (poly)acetal; R₂ is hydrogen or an aliphatic or aromatic hydrocarbon structure as methyl, ethyl, propyl, 2-propyl, butyl, 2-butyl, 3-butyl, benzyl, and the like; n is an integer equal or higher than 1, such as for example, from about to about 10, and from about 1 to about 4; X is a heteroatom containing linking structure such as —NH—, —N< or —O—; and m is an integer of value of 1 unless —X (defined above) is —N<, in which case m is an integer having a value of 2.

A particular example of this structure 1A is structure 1B (illustrated below) where n in structure 1A is n=1. Structure 1B thus represents a monoaldehyde releasing chemical compound with a low temperature biocidal activity and a high temperature breaker activity and with a favorable environmental profile.

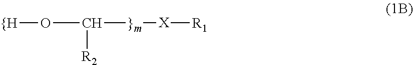

A specific example of a class of monoaldehyde releasing compounds may be the formaldehyde releasing (or donor) compounds, which are also referred to as formaldehyde eliminators or formals. The term “formals” as used herein is a collective term for acetals of formaldehyde, which may be categorized as an N-formals, N,N-diformals, and/or O-formals.

N-formals are reaction products or condensation products of a primary amine or amide function and one formaldehyde-supplying compound resulting in the substitution of one amine hydrogen atom by a hydroxymethyl (—CH₂OH— also referred to as “methylol”) group. In Structure 1A, N-formals would be those structures where —X— is —NH—. Therefore in this disclosure N-formals are reaction products or condensation products of a mono- or polyhydric, amino-substituted C₁- to C₁₀-alkylene, -arylene, -arylalkylene, or -alkylarylene and a formaldehyde-supplying compound, whereby only one hydrogen of the primary amine or amide group have been substituted by a hydroxymethyl group.

N,N-diformals are reaction products or condensation products of a primary amine or amide function and a formaldehyde-supplying compound resulting in substitution of both amine hydrogen atoms by hydroxymethyl groups. In Structure 1A, N,N-diformals would be those structures where —X— is —N<. Therefore in this disclosure, N,N-diformals are the reaction products or condensation products of a mono- or polyhydric, amino-substituted C₁- to C₁₀-alkylene, -arylene, -arylalkylene, or -alkylarylene and a formaldehyde-supplying compound, whereby both hydrogens of the primary amine or amide group have been substituted by a hydroxymethyl group each.

O-formals are reaction products or condensation products of an alcohol function and a formaldehyde-supplying compound. In Structure 1A, O-formals would be those structures where —X— is —O—. Therefore in this disclosure O-formals are reaction products of a mono- or polyhydric C₁- to C₁₀-alkyl, -aryl, -aralkyl alcohol or a glycol or glycol ether and a formaldehyde-supplying compound, resulting in the substitution of the hydrogen atom of the hydroxyl group by a hydroxymethyl group.

Specific example of an aldehyde releasing compounds may also be multiple formaldehyde molecule releasing (or donor) compounds, which are also referred to as polyformals. The term “polyformals” as used herein is a collective term for acetals of formaldehyde with degree of polymerization higher than 1 (thus n>=1 in structure 1A). Examples of polyformals include N-polyformals, N,N-bis(polyformals) and/or O-polyformals.

N-polyformals are reaction products or condensation products of a primary amine or amide function and a formaldehyde-supplying compound, with a degree of polymerization higher than one, therefore n>=1. In Structure 1A, N-polyformals would be those structures where —X— is —NH—. Therefore in this disclosure N-polyformals are reaction products or condensation products of a mono- or polyhydric, amino-substituted C₁- to C₁₀-alkylene, -arylene, -arylalkylene, and -alkylarylene containing structure and a formaldehyde-supplying compound where the formaldehyde polymerizes to a degree of polymerization higher than 1 and only one hydrogen atom of the primary amine is reacted with formaldehyde.

N,N-bis(polyformals) are reaction products or condensation products of a primary amine or amide function and a formaldehyde-supplying compound, with a degree of polymerization higher than one, therefore n>=1. In Structure 1A, N,N-bis(polyformals) would be those structures where —X— is —N<. Therefore, in this disclosure ,N,N-polyformals are reaction products of a mono- or polyhydric amino-substituted C₁₀-alkylene, -arylene, -arylalkylene, and -alkylarylene containing structures and a formaldehyde-supplying compound and a formaldehyde-supplying compound where the formaldehyde polymerizes to a degree of polymerization higher than 1, and both hydrogen atoms of the primary amine are reacted with formaldehyde.

O-polyformals are reaction products or condensation products of an alcohol function and a formaldehyde-supplying compound. In Structure 1A, O-polyformals would be those structures where —X— is —O—. Therefore in this disclosure, O-polyformals are reaction products of a mono- or polyhydric C₁- to C₁₀-alkyl, -aryl, -arylalkyl alcohol or a glycol or glycol ether and a formaldehyde-supplying compound where the formaldehyde polymerizes to a degree of polymerization higher than 1 and where the hydrogen atom of the hydroxyl group is reacted with formaldehyde.

An “alkylene group” refers, for example, to at least a divalent aliphatic group or alkyl group, such as a trivalent or tetravalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, Mg, Li, Ge, Cu, Fe, Ni, Pd, Pt and the like either may or may not be present in the alkylene group.

The term “arylene” refers, for example, to at least a divalent aromatic group or aryl group, such as a trivalent or tetravalent aromatic group or aryl group, including substituted and unsubstituted arylene groups, and wherein heteroatoms, such as O, N, S, P, Si, B, Li, Mg, Cu, Fe and the like either may or may not be present in the arylene group. For example, an arylene group may have about 5 to about 40 carbon atoms in the arylene chain, such as from about 6 to about 14 or from about 6 to about 10 carbon atoms.

The term “arylalkylene” refers, for example, to at least a divalent arylalkyl group, such as a trivalent or tetravalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as O, N, S, P, Si, B, Li, Mg, Cu, Fe, and the like either may or may not be present in either the aryl or the alkyl portion of the arylalkylene group. For example, an arylalkylene group may have about 6 to about 40 carbon atoms in the arylalkylene chain, such as from about 7 to about 22 or from about 7 to about 20 carbon atoms.

The substituents on the substituted hydrocarbon, alkylene, arylene, arylalkylene, and alkylarylene groups can be, for example, halogen atoms, ether groups, aldehyde groups, ketone groups, ester groups, amide groups, imide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanate groups, isocyanate groups, thiocyanate groups, isothiocyanate groups, cyano groups, pyridine groups, pyridinium groups, guanidinium groups, amidine groups, imidazolium groups, carboxylate groups, carboxylic acid groups, urethane groups, urea groups, and mixtures thereof.

A particular case of structure 1A is structure 2A where R₂ in structure 1A is a hydrogen atom. Therefore the structure of interest refers to formaldehyde releasing chemical compounds with a favorable environmental profile.

{H—(O—CH₂—)ₙ}ₘ—X—R₁ (2A)

A particular case of this structure 2A is structure 2B where n in structure 2A is n=1. Therefore the structure of interest refers to one single formaldehyde molecule releasing chemical compounds with a favorable environmental profile

{H—O—CH₂—}ₘ—X—R₁ (2B)

A particular case of structure 1A is Structure 3A where R₁ in structure 1A also comprises additional aldehyde releasing structures.

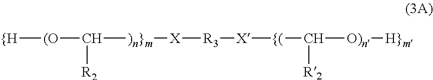

where R₃ is a hydrocarbon linking group structure containing at least carbon and hydrogen atoms, such as, for example, alkylene, arylene and alkylarylene. Specific examples of R₃ include methylene, ethylene, 2-propylene, 3-propylene, 2-butylene, 3-butylene, 4-butylene, o-benzylene, m-benzylene, p-benzylene, substituted benzylenes, and the like or a functional hydrocarbon comprising C, H, N, O, Cl, Br, F, P, and or S. As shown above in Structure 3A, the R₃ moiety is linked to two aldehyde releasing groups where R₂ and R′₂ may be same or different. More specifically, R₂ and R′₂ may be hydrogen or an aliphatic or aromatic hydrocarbon structure as methyl, ethyl, propyl, 2-propyl, butyl, 2 butyl, 3-butyl, benzyl, and the like; n and n′ are each equal or different integer numbers equal or higher than 1, such as for example, from about 1 to about 10 and from about 1 to about 4; X and X′ are each equal or different heteroatom containing linking structures such as —NH—, —N< or —O—; m and m′ are each equal or different integers having a value of 1 with the proviso that if (1) —X— is —N<, m is an integer having a value of 2 or (2) —X′— is —N<, m is an integer having a value of 2.

A particular case of structure 3A is structure 3B where n and n′ in structure 3A are n=1 and n′=1.

$$\text{?} \\ \text{?} \text{indicates text missing or illegible when filed} \qquad ( 3 B )$$

A particular case of structure 3A is structure 4A where the R₂ and R′₂ groups in structure 3A are hydrogen.

{H—(—O—CH₂—)ₙ—}ₘ—X—R₃—X′—{—CH₂—O—)_{n′}—H}_{m′} (4A)

A particular case of structure 4A is Structure 4B where n and n′ in structure 4A are n=1 and n′=1.

{H—O—CH₂—}ₘ—X—R₃—X′—{—CH₂—O—H}_{m′} (4B)

A particular case of structure 1A is structure 5A, where R₁ in the structure 1A can also comprise additional mono or polyaldehyde releasing structures.

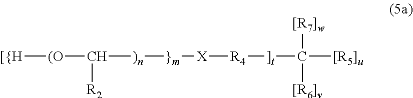

where t, u, v, and w, are integers, such as t≧1, such as the sum t+u+v+w=4, where n is an integer such as n≧1; R₂ is hydrogen or an aliphatic or aromatic hydrocarbon structure as methyl, ethyl, propyl, 2-propyl, butyl, 2 butyl, 3 butyl, benzyl, and the like; R4, is a hydrocarbon structure containing carbon and hydrogen atoms (alkylene, arylene, alkylarylene) such as methylene, ethylene, 2-propylene, 3-propylene, 2 butylene, 3 butylene, 4butylene, o-benzylene, m-benzylene, p-benzylene, substituted benzylenes, and the like and the like or a functional hydrocarbon comprising C, H, N, O, Cl, Br, F, P, and or S; R₅, R₆, and R₇ are hydrocarbon structures containing carbon and hydrogen atoms (alkyl, aryl, alkylaryl) such as methyl, ethyl, 2-propyl, 3-propyl, 2-butyl, 3-butyl, 4-butyl, benzyl, and the like a functional hydrocarbon comprising C, H, N, and or O, or hydrogen atoms, and —X— are heteroatom containing structures such as —O—, —NH—, and —N<; m is an integer of value 1 unless —X— is —N<, in this case m=2.

A particular case of structure 5A is Structure 5B where n in structure 5A is n=1.

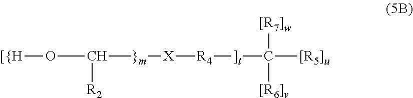

A particular case of structure 1A is structure 6A where R₂ in the structure 1A is hydrogen and R₁ in structure 1A can also comprise additional mono or polyformaldehyde releasing structures

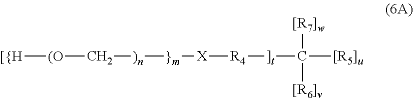

where t, u, v, and w, are integers, such as t≧1, such as the sum t+u+v+w=4 or more, where n is an integer such as n≧1; R₂ is hydrogen or an aliphatic or aromatic hydrocarbon structure as methyl, ethyl, propyl, 2-propyl, butyl, 2 butyl, 3 butyl, benzyl, and the like; R4, is a hydrocarbon structure containing carbon and hydrogen atoms (alkylene, arylene, alkylarylene) such as methylene, ethylene, 2-propylene, 3-propylene, 2 butylene, 3 butylene, 4butylene, o-benzylene, m-benzylene, p-benzylene, substituted benzylenes, and the like and the like or a functional hydrocarbon comprising C, H, N, O, Cl, Br, F, P, and or S; R₅, R₆, and R₇ are hydrocarbon structures containing carbon and hydrogen atoms (alkyl, aryl, alkylaryl) such as methyl, ethyl, 2-propyl, 3-propyl, 2-butyl, 3-butyl, 4-butyl, benzyl, and the like a functional hydrocarbon comprising C, H, N, and or O, or hydrogen atoms, and —X— are heteroatom containing structures such as —O—, —NH—, and —N<; m is an integer of value 1 unless —X— is —N<, in this case m=2.

A particular case of structure 6A is Structure 6B where n in structure 6A is n=1.

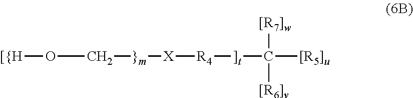

A particular case of structure 5A is structure 7A, where the group R₃ in structure 5A is a polymeric or oligomeric structure such as a polyether or a polyamine with two carbon atoms in between ether or amine groups, therefore derived from a substituted ethylene group.

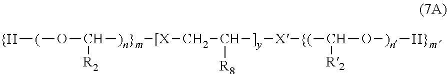

where y is the degree of polymerization of the polyether or polyamine structure, and R₈ is hydrogen or an aliphatic or aromatic hydrocarbon structures such as, for example, as methyl, ethyl, propyl, 2-propyl, butyl, 2 butyl, 3 butyl, benzyl, and the like. The remaining moieties are the same as defined above.

A particular case of structure 7A is structure 7B, where n and n′ in structure 7A are n=1 and n′=1

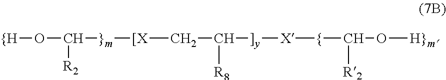

A particular case of structure 7A is structure 8A, where R₈ in structure 8A is hydrogen

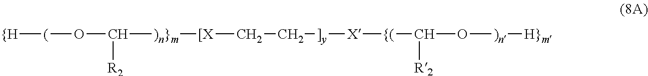

A particular case of structure 8A is structure 8B, where n and n′ in structure 8A are n=1 and n′=1

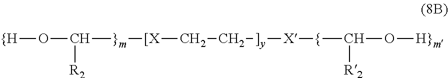

A particular case of structure 7A is structure 9A, where R₈, R₂ and R′₂ are all hydrogen atoms.

{H—(—O—CH₂—)ₙ}ₘ—[X—CH₂—CH₂—]_{y}—X′—{(—CH₂—O—)_{n′}—H}_{m′} (9A)

A particular case of structure 9A is structure 9B, where n and n′ in structure 9A are n=1 and n′=1.

{H—O—CH₂—}ₘ—[X—CH₂—CH₂—]_{y}—X′—{—CH₂—O—H}_{m′} (9B)

A particular case of structure 7A is structure 10A, where y=1.

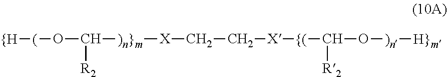

A particular case of structure 10A is structure 10B, where n and n′ in structure 10A are n=1 and n′=1.

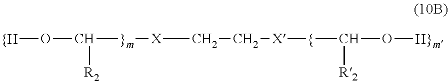

A particular case of structure 7A is structure 11A, where X and X′ are —O—, and thus m=1 and m′=1.

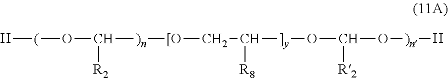

A particular case of structure 11A is structure 11B, where n and n′ in structure 11A are n=1 and n′=1.

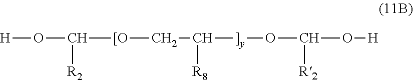

A particular case of structure 11A is structure 12A, where R₂ and R′₂ are hydrogen atoms.

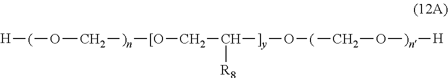

A particular case of structure 12A is structure 12B, where n and n′ in structure 12A are n=1 and n′=1.

$$\text{?} \\ \text{?} \text{indicates text missing or illegible when filed} \qquad ( 12 B )$$

A particular case of structure 12A is structure 13A, where R₈ is hydrogen atom.

H—(—O—CH₂—)ₙ—[O—CH₂—CH₂—]_{y}—O—(—CH₂—O—)_{n′}—H (13A)

A particular case of structure 13A is structure 13B, where n and n′ in structure 13A are n=1 and n′=1

H—O—CH₂—[O—CH₂—CH₂—]_{y}—O—CH₂—O—H (13B)

A particular case of structure 8A is structure 14A, where X and X′ in structure 8A are —O—, and thus m=1 and m′=1 and where y in structure 8A is y=1.

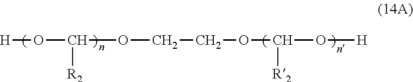

A particular case of structure 14A is structure 14B, where n and n′ in structure 14A are n=1 and n′=1.

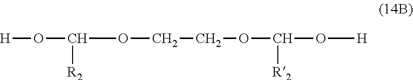

A particular case of structure 14A is structure 15A, where R₂ and R′₂ in structure 14A are hydrogen.

H—(—O—CH₂—)ₙ—O—CH₂—CH₂—O—(—CH₂—O—)_{n′}—H (15A)

A particular case of structure 15A is structure 15B, where n and n′ in structure 15A are n=1 and n′=1. Such a compound may be referred to as (ethylenedioxy)dimethanol.

H—O—CH₂—O—CH₂—CH₂—O—CH₂—O—H (15B)

A particular case of structure 7A is structure 16A, where X and X′ in structure 7A are —NH—, and thus m=1 and m′=1.

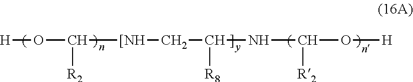

A particular case of structure 16A is structure 16B, where n and n′ in structure 16A are n=1 and n′=1.

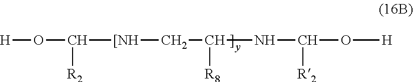

A particular case of structure 16A is structure 17A, where R₂ and R′₂ in structure 16A are hydrogen atoms.

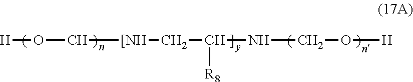

A particular case of structure 17A is structure 17B, where n and n′ in structure 17A are n=1 and n′=1.

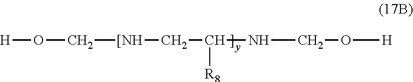

A particular case of structure 17A is structure 18A, where R₈ in structure 17A is hydrogen atom.

H—(—O—CH₂—)ₙ—[NH—CH₂—CH₂—]_{y}—NH—(—CH₂—O—)_{n′}—H (18A)

A particular case of structure 18A is structure 18B, where n and n′ in structure 18A are n=1 and n′=1.

H—O—CH₂—[NH—CH₂—CH₂—]_{y}—NH—CH₂—O—H (18B)

A particular case of structure 16A is structure 19A, where R₈ in structure 16A is hydrogen atom and where y in structure 16A is y=1.

$$\text{?} \\ \text{?} \text{indicates text missing or illegible when filed} \qquad ( 19 A )$$

A particular case of structure 19A is structure 19B, where n and n′ in structure 19A are n=1 and n′=1

$$\text{?} \\ \text{?} \text{indicates text missing or illegible when filed} \qquad ( 19 B )$$

A particular case of structure 19A is structure 20A, where R₂ and R′₂ in structure 19A are hydrogen.

H—(—O—CH₂—)ₙ—NH—CH₂—CH₂—NH—(—CH₂—O—)_{n′}—H (20A)

A particular case of structure 20A is structure 20B, where n and n′ in structure 20A are n=1 and n′=1. This structure may also be referred to as N,N′dimethylol ethylenediamine.

H—O—CH₂—NH—CH₂—CH₂—NH—CH₂—O—H (20B)

A particular case of structure 10A is structure 21A, where X and X′ in structure 10A are —N< and thus m=2 and m′=2 and where y in structure 10A y=1.

$$\text{?} \\ \text{?} \text{indicates text missing or illegible when filed} \qquad ( 21 A )$$

A particular case of structure 21A is structure 21B, where n and n′ in structure 21A are n=1 and n′=1.

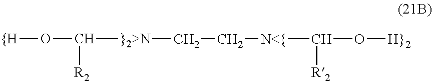

A particular case of structure 21A is structure 22A, where R₂ and R′₂ are hydrogen.

{H—(—O—CH₂—)ₙ}₂>N—CH₂—CH₂—N<{—(CH₂—O—H)_{n′}}₂ (22A)

A particular case of structure 22A is structure 22B, where n and n′ in structure 22A are n=1 and n′=1. This structure may also be referred to as N,N,N′,N′tetramethylol ethylenediamine.

{H—O—CH₂—}₂>N—CH₂—CH₂—N<{—CH₂—O—H}₂ (22B)

A particular case of structure 3A is structure 23A, where the R3 moiety or group in structure 3A is a polymeric or oligomeric structure such as a polyether or a polyamine with more than two carbon atoms in between ether or amine groups, therefore derived from a polymethylene group.

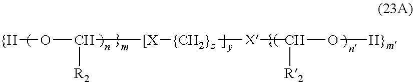

where z is an integer of from 1 to 10, such as, for example an integer equal to 1 (thus making R₃ in structure 3A a methylene bridge), equal to 2 (thus making R₃ in structure 3A an ethylene bridge) or larger than 2, such as, for example, an integer of 3 (thus making R₃ in structure 3A an n-propylene bridge), or an integer of 4 (thus making R₃ in structure 3A an n-butylene bridge). Examples of repeating units where X is —O— for different values of z would be polyformal where z=1, polyethylene oxide where z=2, poly (n-propylene oxide) where z=3, poly(n-butylene oxide) where z=4. Examples of repeating units where X is —NH— for different values of z would be polymethyleneamine where z=1, polyethyleneamine where z=2, poly(n-propylene) amine where z=3, or poly(n-butylene) amine where z=4.

A particular case of structure 23A is structure 23B, where n and n′ in structure 23A are n=1 and n′=1.

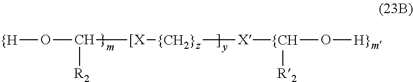

A particular case of structure 23A is structure 24A, where R₂ and R′₂ in structure 23A are hydrogen.

{H—(—O—CH₂—)ₙ}ₘ—[X—{CH₂}_{z}—]_{y}—X′—{(—CH₂—O—)_{n′}—H}_{m′} (24A)

A particular case of structure 24A is structure 24B, where n and n′ in structure 24A are n=1 and n′=1.

{H—O—CH₂}ₘ—[X—{CH₂}_{z}—]_{y}—X′—{CH₂—O—H}_{m′} (24B)

A particular case of structure 23A is structure 25A, where X and X′ are —O— and therefore m=1 and m′=1.

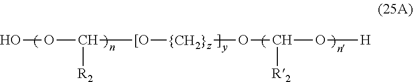

A particular case of structure 25A is structure 25B, where n and n′ in structure 25A are n=1 and n′=1.

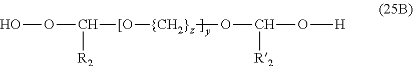

A particular case of structure 25A is structure 26A, where R₂ and R′2 in structure 25A are hydrogen.

H—(—O—CH₂—)ₙ—[O—{CH₂}_{z}—]_{y}—O—(—CH₂—O—)_{n′}—H (26A)

A particular case of structure 26A is structure 26B, where n and n′ in structure 26A are n=1 and n′=1.

H—O—CH₂—[O—{CH₂}_{z}—]_{y}—O—CH₂—O—H (26B)

A particular example of structure 26A, where z=4 and y=1 is butyleneglycoloxy dimethanol as shown below in structure 26C

H—O—CH₂—O—{CH₂}₄—O—CH₂—O—H (26C)

A particular case of structure 23A is structure 27A, where X and X′ are —NH— and therefore m=1 and m′=1.

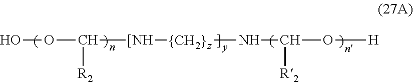

A particular case of structure 27A is structure 27B, where n and n′ in structure 27A are n=1 and n′=1.

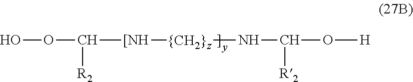

A particular case of structure 27A is structure 28A, where R₂ and R′₂ in structure 27A are hydrogen.

H—(—O—CH₂—)ₙ—[NH—{CH₂}_{z}—]_{y}—NH—(—CH₂—O—)_{n′}—H (28A)

A particular case of structure 28A is structure 28B, where n and n′ in structure 28A are n=1 and n′=1.

H—O—CH₂—[NH—{CH₂}_{z}—]_{y}—NH—CH₂—O—H (28B)

A particular example of Structure 28B, where z=4 is N,N′ dimethylol 1,4 butylenediamine, as illustrated by the below structure 28C.

H—O—CH₂—NH—{CH₂}₄—NH—CH₂—O—H (28C)

It is understood that all the structures disclosed herein are derived from the generic structure 1A and that all structures disclosed here are to be considered exemplary in nature.

With respect to the value of the degrees of polymerization n and or n′, in structures 1A, 2A, 3A, 4A, 5A, 6A, 7A, 8A, 9A, 10A, 11A, 12A, 13A, 14A, 15A, 16A, 17A, 18A, 19A, 20A, 21A, or 22A,23A, 24A, 25A, 26A, 27A and 28A it is possible that a distribution of molecules each with integer values of n>=1 and or n′>=1 could be the result of the manufacturing process of the respective chemical structures, and in such a mixture, the average degrees of polymerization n and or n′ could take any value not necessarily an integer value. Typical values of n and n′ will not be substantially higher than 10, and will not often be higher than 20.

With respect to the value of the degree of polymerization y in structures 7A, 7B, 8A, 8B, 9A, 9B, 11A, 11B, 12A, 12B, 13A, 13B, 16A, 16B, 17A, 17B, 18A, 18B, 23A, 23B, 24A, 24B, 25A, 25B, 26A, 26B, 27A, 27B, 28A, and 28B it is possible that a distribution of molecules each with integer values of y>=1 could be the result of the manufacturing process of the chemical structure, and in such a mixture, the average degree of polymerization y could take any value not necessarily an integer value. Typical values of y will not be substantially higher than 10, and will not often be higher than 20.

Specific examples of the structures described herein are various O-formals. O-formals include formaldehyde condensations products with diols, such as with ethylene glycol, (ethylenedioxy)dimethanol, or with polyethylene glycol (polyethylenglycoloxy)dimethanol, (ethylenedioxy)benzyl alcohol hemiformal, with propylene glycol such as propylene glycol hemiformal, (propyleneglycoloxy)dimethanol, or with polypropylene glycol such as polypropylene glycol hemiformal or (polypropyleneglycoloxy)dimethanol, and with butyl glycol such as butyl diglycol hemiformal or (polybutyleneglycoloxy)dimethanol, 2 bromo. 2 nitro 1-3 propanediol.

Specific examples of the structures described herein are various examples of N-formals include (ethylenediamine)dimethanol;benzylamine dimethanol urea-formaldehyde adducts, such as 1,3-bis(hydroxymethyl)urea, tetrahydro-1,3,4,6-tetrakis{hydroxymethyl}imidazole[4,5-d]imidazole-2,5{1H,3H}-dione (Protectol 140), N,N″-methylenebis[N′-[3-hydroxymethyl)-2,5-dioxoimidazolidin-4-yl]urea] (imidazolidinylurea), 1-[1,3-bis(hydroxymethyl)-2,5-dioxoimidazolidin-4-yl]-1,3-bis(hydroxymethyl)urea (diazolidinylurea), 1,3-bis(hydroxymethyl)-5,5-dimethylimidazolidine-2,4-dione (DMDMH), amino acid derivatives, such as N-hydroxymethylglycine or salts, N,N′,N″-tris(hydroxyethyl)hexahydrotriazine, N,N′,N″-tris(β-hydroxypropyl)hexahydrotriazine, N-methylolchloroacetamide, cis-isomer of 1-(3-chloroallyl)-3,5,7-triaza-1-azonia-adamantane chloride, 1-(3-chloroallyl)-3,5,7-triaza-1-azonia-adamantane chloride, 5-(polyoxymethylene)-1-aza-3,7-dioxabicyclo[3.3.0]octane, ({[1-methyl-2-(5-methyloxazolidin-3-yflethoxy]methoxy}-methoxy)methanol, 4,4-dimethyloxazolidine, 7a-ethyldihydro-1H,3H,5H-oxazolo[3,4-c]oxazole, 2-(hydroxymethylamino)ethanol, 1-(hydroxymethylamino)-2-propanol and N,N′-methylenebis(5-methyloxazolidine).

The aldehyde releasing compound may be present in the treatment fluid in an amount of at least 0.25 gallons per 1000 gallons (gpt), such as for example, from about 0.25 gpt to about 3 gpt, from about 0.5 gpt to about 2 gpt and from about 1.0 gpt to about 1.5 gpt.

As discussed above, the aldehyde releasing compounds are considered to be a multifunctional additive that at least functions as a biocide at least low temperature and a breaker at least at high temperature. Low temperatures are temperatures in between −10 degrees Celsius and 60 degrees Celsius. High temperatures are temperatures in between 50 degrees Celsius and 232 degrees Celsius.

Biocides have been used fracturing applications to prevent souring of the reservoir by controlling sulfur reducing bacteria (SRB), and to maintain the fluid properties, such as fluid viscosity and suspension capability. The fracturing fluids can be prepared and stored in tanks for several days before use. The compatibility of different chemicals is also very important, as the biocide is needs to be compatible with other chemicals used in the fracturing fluid formulation. The most commonly used polymer is natural polysaccharide such as, for example, guar gum, which is very sensitive to bacteria. The presence of bacteria can destroy polymer fluid viscosity due to the enzymes produced by bacteria. The presence of enzymes breaks the molecular chain of the polymer and cause polymer gel degradation negatively affecting the suspension capability of the polymer fluid and its ability to create propagate fracture and limit undesirable fluid loss to the formation. In addition in some high temperature fracturing applications the use of bromate breakers might not be desirable due to their mildly toxic nature to some aquatic organisms. In this case the use of a multifunctional additive that can be environmentally friendly and that can provide bacterial growth control at low (surface) temperatures and can act as a fluid breaker at high (reservoir) temperatures is a viable alternative to traditional oxidative breakers.

There are two types of bacteria, aerobic (require oxygen for survival) and anaerobic (survive without oxygen). Aerobic bacteria produce enzymes that degrade the gelling agents used in polymer gels and fracturing fluids resulting in a viscosity loss and premature breaking of the fluid. Anaerobic bacteria can create severe reservoir problems. The bacteria can multiply in such numbers that they reduce permeability and, consequently, damage the formation. Certain types of anaerobic bacteria chemically reduce sulfate ions to produce hydrogen sulfide, creating a safety hazard. Hydrogen sulfide also corrodes tubular goods and production equipment. Additional description regarding the properties of biocides and/or is described in U.S. Patent Application Pub. No. 2012/0285693, the disclosure of which is incorporated by reference herein in its entirety.

In embodiments, the aldehyde releasing compound may function as biocide by reducing the bacteria present in the treatment fluid by at least one order of magnitude while the treatment fluid is present in a temperature range of from about −10° C. to about 60° C., such as, from about 0° C. to about 50° C., from about 10° C. to about 45° C., from about 20° C. to about 40° C. and from about from about 25° C. to about 35° C. The amount of bacteria in the treatment fluid may be represented by the colony-forming unit (CFU). Therefore, the aldehyde releasing compound may reduce the bacteria one order of magnitude to about eight orders of magnitude, such as, for example two orders of magnitude to seven orders of magnitude, three orders of magnitude to six orders of magnitude or four orders of magnitude. Furthermore, the aldehyde releasing compound may reduce the bacteria to be less than 1×10³ CFU, which may be appropriate for a majority of the subterranean formation treatment operations using the aldehyde releasing compound.

In embodiments, the “reaction” of the viscosified fluid (viscosified treatment fluid” or “viscosified fluid for treatment) with the aldehyde releasing compound to reduce the viscosity of the viscosified fluid (the breaking effect) occurs at specified temperatures. In embodiments, the “reaction” of the viscosified fluid (viscosified treatment fluid” or “viscosified fluid for treatment) with the aldehyde releasing compound to reduce the viscosity of the viscosified fluid (the breaking effect) does not substantially occur, or does not occur, until the breaking agent is exposed to the subterranean conditions, such as a specified temperature in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.). In some embodiments, such a reaction, which may include the aldehyde releasing compound reacting with the polymeric material of the viscosified fluid to decompose and/or depolymerize the polymeric material of the viscosified fluid, does not substantially occur, or does not occur, until the breaking agent is down hole and exposed to heat, such as a sufficient heat to initiate the breaking effect of the breaking agent.

The design of fracturing treatments is described in U.S. Pat. No. 7,337,839, which is incorporated herein by reference in its entirety. Although the present disclosure describes the use of an aldehyde releasing compound in fracturing treatments, it can also be used in other treatments.

The aldehyde releasing compound may initially be in a solid or liquid form. When in a solid form, the aldehyde releasing compound may be crystalline or granular materials. The solid form may be encapsulated or provided with a coating to delay its release into the treatment fluid. Encapsulating materials and methods of encapsulating breaking materials are known in the art. Such materials and methods may be used for the aldehyde releasing compound of the present disclosure. Non-limiting examples of materials and methods that may be used for encapsulation are described, for instance, in U.S. Pat. Nos. 4,741,401; 4,919,209; 6,162,766 and 6,357,527, the disclosures of which are incorporated herein by reference in their entireties. Methods to encapsulate liquids are also available to the industry.

When used as a liquid or fluid, the aldehyde releasing compound is commonly dissolved in an aqueous solution. The aldehyde releasing compound is generally soluble in water, that is, the breaking agents have a solubility of at least greater than 1 g in 100 g of water at room temperature, as measured using iodometric titration methods. The aldehyde releasing compound of the present disclosure may have solubilities of 5 g or more in 100 g of water, such as 10 g or more in 100 g of water.

The aldehyde releasing compound may be added to the viscosified or unviscosified treatment fluid before this fluid is introduced into the well bore, or the aldehyde releasing compound may be added as a separate fluid, such as an aqueous or organic based fluid, that is introduced into the wellbore after at least a portion or the entire amount of viscosified or unviscosified treatment fluid has been introduced into the wellbore.

The amount of the aldehyde releasing compound present in the viscosified or unviscosified treatment fluid (or aqueous or organic based fluid) may depend on several factors including the specific aldehyde releasing compound selected, the amount and ratio of the other components in the viscosified or unviscosified treatment fluid (or aqueous or organic based fluid), the contacting time desired, the temperature, pH, and ionic strength of the viscosified or unviscosified treatment fluid (or aqueous or organic based fluid).

In embodiments where in the aldehyde releasing compound is introduced in a fluid separate from the viscosified or unviscosified fluid, the aldehyde releasing compound may be incorporated into an aqueous or organic based fluid in which the breaking agent may present in an amount above about 0.001% by weight of the aqueous or organic based fluid, such as in an amount from about 0.002% to about 0.1% by weight of aqueous or organic based fluid, in an amount from about 0.003% to about 0.01% by weight of the aqueous or organic based fluid, or in an amount from about 0.004% to about 0.008% by weight of the aqueous or organic based fluid.

The aldehyde releasing compound may be present in the viscosified or unviscosified fluid (added before introducing the viscosified or unviscosified treatment fluid into the wellbore) in an amount above about 0.001% by weight of the viscosified or unviscosified fluid, such as in an amount from about 0.01% to about 0.6% by weight of the viscosified or unviscosified fluid, in an amount from about 0.04% to about 0.3% by weight of the viscosified or unviscosified fluid, or in an amount from about 0.05% to about 0.01% by weight of the viscosified or unviscosified fluid. In such embodiments, the concentration ratio of the aldehyde releasing compound to the polymeric material (aldehyde releasing compound: polymeric material) in the viscosified or unviscosified fluids may be in a range of from about 1:100 to about 1:4, such as a concentration ratio in range of from about 1:50 to about 1:5, a concentration ratio in range of from about 1:40 to about 1:6, or a concentration ratio in range of from about 1:30 to about 1:7.

As used herein, the phrases “viscosified fluid,” “viscosified treatment fluid” or “viscosified fluid for treatment” (hereinafter generally referred to as a “viscosified fluid” unless specified otherwise) mean, for example, a composition comprising a solvent, a viscosifying material, such as a polymeric material, which may include any crosslinkable compound and/or substance with a crosslinkable moiety (hereinafter “crosslinkable component”), and aldehyde releasing compound. The viscosified fluids of the present disclosure may be substantially inert to any produced fluids (gases and liquids) and other fluids injected into the wellbore or around the wellbore.

The aldehyde releasing compound of the present disclosure may be activated to initiate the “reaction” of the viscosified treatment fluid with the aldehyde releasing compound to reduce the molecular weight of the polymeric materials (the breaking effect). In embodiments, the aldehyde releasing compound of the present disclosure may be initiated by subterranean environmental conditions, such as temperature or pH, of the subterranean zone in which they are placed.

In embodiments when aldehyde releasing compound is added to the viscosified or unviscosified treatment fluid either before or after the fluid is introduced into the well bore, the “reaction” of the viscosified treatment fluid with the aldehyde releasing compound (the breaking effect) does not substantially occur until the aldehyde releasing compound is exposed to an intermediate temperature, such as downhole or subterranean conditions where the temperature is in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.). In other words, the reduction of the viscosity, such as the viscosity reduction as a result of the aldehyde releasing compound reacting with the polymeric material of the viscosified fluid to decompose and/or depolymerize the polymeric material, of the viscosified fluid does not substantially occur until the aldehyde releasing compound is down hole and exposed to heat, such as a sufficient heat to initiate the breaking effect of the aldehyde releasing compound. For example, at least 90% of the polymeric material remains unreacted (or unbroken in that the molecular weight of the polymeric material remains unchanged), such as at least 95%, or as at least 99% of the polymeric material remains unreacted before the aldehyde releasing compound is exposed to an intermediate temperature, such as downhole or subterranean conditions where the temperature is in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), that may act to initiate the breaking effect of the aldehyde releasing compound.

In specific embodiments, the reduction of the viscosity, such as the viscosity reduction as a result of the aldehyde releasing compound acting to decompose and/or depolymerize the polymeric material, of the viscosified fluid does not occur to any extent until the aldehyde releasing compound is exposed to a specified temperature, such as downhole or subterranean conditions where the temperature is in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), that would initiate the breaking effect of the breaking agent.

In embodiments, the above breaking effect of the aldehyde releasing compound may begin in at a time from about 5 minutes to about 600 minutes after being exposed to the intermediate temperature, such as a subterranean zone temperature or fracture temperature in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), such as a time from about 10 minutes to about 300 minutes, a time from about 15 minutes to about 150 minutes, a time from about 15 minutes to about 90 minutes, a time from about 15 minutes to about 60 minutes, a time from about 15 minutes to about 30 minutes, or a time from about 15 minutes to about 20 minutes after being exposed to the specified temperature, such as a subterranean zone temperature or fracture temperature in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.).

In embodiments, the breaking effect of the breaking agent may be accomplished either in the presence or absence of a breaker activator (also referred to as a “breaking aid”). A breaker activator may be present to encourage the redox cycle that activates the aldehyde releasing compound. In some embodiments, the breaker activator may comprise an amine, such as an oligoamine activators, for example, tetraethylenepentaamine (TEPA) and pentaethylenehexaamine (PEHA); or a metal chelated with chelating agents. Suitable metals may include iron, chromium, copper, manganese, cobalt, nickel, vanadium, aluminum, and boron. Further breaker aids may include ureas, ammonium chloride and the like, and those disclosed in, for example, U.S. Pat. Nos. 4,969,526, and 4,250,044, the disclosures of which are incorporated herein by reference in their entireties.

The amount of breaker activator that may be included in the viscosified or unviscosified treatment fluid (or aqueous or organic based fluid) is an amount that will sufficiently activate the breaking effect of the aldehyde releasing compound. Factors including the injection time desired, the polymeric material and its concentration, and the formation temperature. In embodiments, the breaker activator will be present in the viscosified or unviscosified treatment fluid (or aqueous or organic based fluid) in an amount in the range of from about 0.01% to about 1.0% by weight, such as from about 0.05% to about 0.5% by weight, of the viscosified or unviscosified treatment fluid (or aqueous or organic based fluid). In specific embodiments, no breaker activator may be present to sufficiently activate the breaking effect of the aldehyde releasing compound.

The polymers present in the viscosified fluid may be those commonly used with fracturing fluids. The polymers may be used in either crosslinked or non-crosslinked form. The polymers may be capable of being crosslinked with any suitable crosslinking agent, such as metal ion crosslinking agents. Examples of such materials include the borate ion (boron) or the polyvalent metal ions of aluminum, antimony, zirconium, titanium, chromium, etc., that react with the polymers to form a composition with adequate and targeted viscosity properties for various operations. The crosslinking agent may be added in an amount that results in suitable viscosity and stability of the gel at the temperature of use. Crosslinkers may be added at concentrations of about 5 to about 500 parts per million (ppm) of active atomic weight. That concentration may be adjusted based on the polymer concentration.

The crosslinker may be added as a solution and may include a ligand which delays the crosslinking reaction. This delay may be beneficial in that the high viscosity fracturing fluid is not formed until near the bottom of the wellbore to minimize frictional pressure losses and may prevent irreversible shear degradation of the gel, such as when Zr or Ti crosslinking agents are used. Delayed crosslinking may be time, temperature or both time and temperature controlled to facilitate a successful fracturing process.

The polymers and amount used in the viscosified fluid may provide a fluid viscosity (from about 1 cP to about 100,000 cP at the treating temperature) that is sufficient to generate fracture width and facilitate transport and prevention of undue settling of the proppant within the fracture during fracture propagation. Generally, the polymer concentration is reduced to avoid proppant pack damage and maintain sufficient viscosity for opening the fracture and transporting proppant. In embodiments, the concentration of polymer may be selected to facilitate a primary goal of higher proppant loading in the fracture.

In embodiments, the viscosified fluids of the present disclosure may also be prepared from a fluid with crosslinkable components initially having a very low viscosity that can be readily pumped or otherwise handled and that are subsequently crosslinked, such as once it is downhole, to form the viscosified fluid. For example, the viscosity of the initial fluid with crosslinkable components may be from about 1 cP to about 10,000 cP, or be from about 1 cP to about 1,000 cP, or be from about 1 cP to about 100 cP at the treating temperature, which may range from a surface temperature to a bottom-hole static (reservoir) temperature. In embodiments, the aldehyde releasing compound may be present in the fluid with crosslinkable components initially having such a very low viscosity.

Crosslinking the unviscosified fluid with crosslinkable components generally increases its viscosity. As such, having the fluid in the unviscosified state allows for pumping of a relatively less viscous fluid having relatively low friction pressures within the well tubing, and the crosslinking may be delayed in a controllable manner such that the properties of viscosified fluid are available at the rock face instead of within the wellbore. Such a transition to a viscosified fluid state may be achieved over a period of minutes or hours based on the molecular make-up of the crosslinkable components, and results in the initial viscosity of the crosslinkable fluid increasing by at least an order of magnitude, such as at least two orders of magnitude. In embodiments, the aldehyde releasing compound may be present in such crosslinked viscosified fluid. In embodiments, after the viscosity of the fluid has increased by at least an order of magnitude, such as at least two orders of magnitude, the action of the aldehyde releasing compound may decrease the viscosity of the viscosified fluid by at least an order of magnitude (for example, reducing the viscosity from about 1,000 centipoise at 100 sec⁻¹ at the treating temperature to about 100 centipoise at 100 sec⁻¹ at the treating temperature) such as at least two orders of magnitude at the treating temperature, or to a viscosity below that of the initial unviscosified fluid (for example from about 10,000 centipoise at 100 sec⁻¹ at the treating temperature to about 100 centipoise at 100 sec⁻¹ at the treating temperature).

In embodiments, the action (the breaking effect) of the aldehyde releasing compound may reduce the viscosity of the viscosified fluid by at least one order of magnitude while the viscosified fluid is at a temperature in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), such as reducing the viscosity of the viscosified fluid by at least about one order of magnitude to about three orders of magnitude, or reducing the viscosity of the viscosified fluid by at least about one order of magnitude to about two orders of magnitude while the viscosified fluid is at a temperature in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.).

In embodiments, the action (the breaking effect) of the aldehyde releasing compound may reduce the viscosity of the viscosified fluid by at least 80% based upon the initial viscosity of the viscosified fluid, or by at least 95%, while the viscosified fluid is at a temperature in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), such as reducing the viscosity of the viscosified fluid by at least 80% to about 99.99%, or reducing the viscosity of the viscosified fluid by at least about 95% to about 99% while the viscosified fluid is at a temperature in the range of from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.).

The unviscosified fluids or compositions suitable in the methods of the present disclosure may comprise a crosslinkable component. As discussed above, a “crosslinkable component,” as the term is used herein, is a compound and/or substance that comprises a crosslinkable moiety capable of being crosslinked by a crosslinking agent. Suitable crosslinking agents for the methods of the present disclosure would be capable of crosslinking polymer molecules to form a three-dimensional network. Suitable inorganic crosslinking agents include, but are not limited to, polyvalent metals, conventional chelated polyvalent metals, and compounds capable of yielding polyvalent metals. The concentration of the cross linking agent in the crosslinkable fluid may be from about 0.001 wt % to about 10 wt %, such as about 0.005 wt % to about 2 wt %, or about 0.01 wt % to about 1 wt %.

The crosslinkable component may be natural or synthetic polymers (or derivatives thereof) that comprise a crosslinkable moiety, for example, substituted galactomannans, guar gums, high-molecular weight polysaccharides composed of mannose and galactose sugars, or guar derivatives, such as hydrophobically modified guars, guar-containing compounds, and synthetic polymers. Suitable crosslinkable components may comprise a guar gum, a locust bean gum, a tara gum, a honey locust gum, a tamarind gum, a karaya gum, an arabic gum, a ghatti gum, a tragacanth gum, a carrageenen, a succinoglycan, a xanthan, a diutan, a hydroxylethylguar hydroxypropyl guar, a carboxymethylhydroxyethyl guar, a carboxymethylhydroxypropylguar, an alkylcarboxyalkyl cellulose, an alkyl cellulose, an alkylhydroxyalkyl cellulose, a carboxyalkyl cellulose ether, a hydroxyethylcellulose, a carboxymethylhydroxyethyl cellulose, a carboxymethyl starch, a copolymer of 2-acrylamido-2methyl-propane sulfonic acid and acrylamide, a terpolymer of 2-acrylamido-2methyl-propane sulfonic acid, acrylic acid, acrylamide, or derivatives thereof. In embodiments, the crosslinkable components may present at about 0.01% to about 4.0% by weight based on the total weight of the crosslinkable fluid, such as at about 0.10% to about 2.0% by weight based on the total weight of the crosslinkable fluid.

Suitable solvents for use with the unviscosified fluid, viscosified fluid, and/or aldehyde releasing compound may be aqueous or organic based. In embodiments, the aldehyde releasing compound may be introduced into the subterranean formation in a fluid (aqueous or organic) that is separate from the unviscosified fluid or viscosified fluid. In embodiments, the aldehyde releasing compound may be introduced into the subterranean formation after being mixed into either an unviscosified fluid or a viscosified fluid. Aqueous solvents may include at least one of fresh water, sea water, brine, mixtures of water and water-soluble organic compounds and mixtures thereof. Organic solvents may include any organic solvent which is able to dissolve or suspend the various components of the crosslinkable fluid.

In embodiments, the solvent, such as an aqueous solvent, may represent up to about 99.9 weight percent of the unviscosified or viscosified fluid, such as in the range of from about 85 to about 99.9 weight percent of the viscosified fluid, or from about 98 to about 99.7 weight percent of the viscosified fluid.

While the viscosified fluids or viscosified treatment fluids of the present disclosure are described herein as comprising the above-mentioned components, it should be understood that the fluids of the present disclosure may optionally comprise other chemically different materials. In embodiments, the unviscosified and/or viscosified fluids of the present disclosure may further comprise stabilizing agents, surfactants, diverting agents, or other additives. Additionally, the unviscosified and/or viscosified fluids may comprise a mixture of various crosslinking agents, and/or other additives, such as fibers or fillers, provided that the other components chosen for the mixture are compatible with the intended application. In embodiments, the unviscosified and/or viscosified fluids of the present disclosure may further comprise one or more components selected from the group consisting of a conventional gel breaker, a buffer, a proppant, a clay stabilizer, a gel stabilizer and a surfactant. Furthermore, the unviscosified and/or viscosified fluids may comprise buffers, pH control agents, and various other additives added to promote the stability or the functionality of the fluid. The unviscosified and/or viscosified fluids may be based on an aqueous or non-aqueous solution. The components of the unviscosified and/or viscosified fluids may be selected such that they may or may not react with the subterranean formation that is to be sealed.

In this regard, the unviscosified and/or viscosified fluids may include components independently selected from any solids, liquids, gases, and combinations thereof, such as slurries, gas-saturated or non-gas-saturated liquids, mixtures of two or more miscible or immiscible liquids, and the like, as long as such additional components allow for the breakdown of the three dimensional structure upon substantial completion of the treatment. For example, the unviscosified and/or viscosified fluids may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the crosslinkable fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure of the viscosified fluid after its formation downhole. Stabilizing agents may include buffering agents, such as agents capable of buffering at pH of about 8.0 or greater (such as water-soluble bicarbonate salts, carbonate salts, phosphate salts, or mixtures thereof, among others); and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others), which may or may not be the same as used for the coordinated ligand system of the chelated metal of the spread crosslinker. Buffering agents may be added to the crosslinkable fluid or treatment fluid in an amount from about 0.05 wt % to about 10 wt %, and from about 0.1 wt % to about 2 wt %, based upon the total weight of the unviscosified and/or viscosified fluids. Chelating agents may also be added to the unviscosified and/or viscosified fluids.

The aqueous base fluids of the fluids of the present application may generally comprise fresh water, salt water, sea water, a brine (e.g., a saturated salt water or formation brine), or a combination thereof. Other water sources may be used, including those comprising monovalent, divalent, or trivalent cations (e.g., magnesium, calcium, zinc, or iron) and, where used, may be of any weight.

Chelation is the formation or presence of two or more separate bindings between a multiple-bonded ligand and a single central atom. These ligands may be organic compounds, and are called chelating agents, chelants, or chelators. A chelating agent forms complex molecules with certain metal ions, inactivating the ions so that they cannot normally react with other elements or ions to produce precipitates or scale. Example of chelating agents include nitrilotriacetic acid (NTA); citric acid; ascorbic acid; hydroxyethylethylenediaminetriacetic acid (HEDTA) and its salts, including sodium, potassium, and ammonium salts; ethylenediaminetetraacetic acid (EDTA) and its salts, including sodium, potassium, and ammonium salts; diethylenetriaminepentaacetic acid (DTPA) and its salts, including sodium, potassium, and ammonium salts; phosphinopolyacrylate; thioglycolates; and a combination thereof. Other chelating agent are: aminopolycarboxylic acids and phosphonic acids and sodium, potassium and ammonium salts thereof; HEIDA (hydroxyethyliminodiacetic acid); other aminopolycarboxylic acid members, including already EDTA and NTA (nitrilotriacetic acid), but also: DTPA (diethylenetriamine-pentaacetic acid), and CDTA (cyclohexylenediamintetraacetic acid) are also suitable; phosphonic acids and their salts, including ATMP (aminotri-(methylenephosphonic acid)), HEDP (1-hydroxyethylidene-1,1-phosphonic acid), HDTMPA (hexamethylenediaminetetra-(methylenephosphonic acid)), DTPMPA (diethylenediaminepenta-(methylenephosphonic acid)), and 2-phosphonobutane-1,2,4-tricarboxylic acid.

Aqueous fluid embodiments may also comprise an organoamino compound. Examples of suitable organoamino compounds may include tetraethylenepentamine (TEPA), triethylenetetramine, pentaethylenehexamine, triethanolamine, and the like, or any mixtures thereof. When organoamino compounds are used in fluids described herein, they are incorporated at an amount from about 0.01 wt % to about 2.0 wt % based on total liquid phase weight. The organoamino compound may be incorporated in an amount from about 0.05 wt % to about 1.0 wt % based on total weight of the fluid.

Thermal stabilizers may also be included in the viscosified or unviscosified fluids. Examples of thermal stabilizers include, for example, alcohols, such as methanol, or triethanolamine, substituted phenols such as hydroquinone, resorcinol, catechol, dimethoxy phenol, or tannic acid, sulfur containing reducing agents such as alkali metal thiosulfates, such as sodium thiosulfate, and ammonium thiosulfate. The concentration of thermal stabilizer in the fluid may be from about 0.1 to about 5 weight %, from about 0.2 to about 2 weight %, from about 0.2 to about 1 weight %, from about 0.5 to about 1 weight % of the thermal stabilizers based on the total weight of the fracturing fluid.

One or more clay stabilizers may also be included in the viscosified or unviscosified fluids. Suitable examples include hydrochloric acid and chloride salts, such as, choline chloride, tetramethylammonium chloride (TMAC) or potassium chloride. Aqueous solutions comprising clay stabilizers may comprise, for example, 0.05 to 0.5 weight % of the stabilizer, based on the combined weight of the aqueous liquid and the organic polymer (i.e., the base gel).

Surfactants can be added to promote dispersion or emulsification of components of the unviscosified and/or viscosified fluids, or to provide foaming of the crosslinked component upon its formation downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. Nos. 6,703,352; 6,239,183; 6,506,710; 7,303,018 and 6,482,866, the disclosures of which are incorporated herein by reference in their entireties, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944 (available from Baker Petrolite of Sugar Land, Tex.). A surfactant may be added to the crosslinkable fluid in an amount in the range of about 0.01 wt % to about 10 wt %, such as about 0.1 wt % to about 2 wt %.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

The viscosifying agent may be a viscoelastic surfactant (VES). The VES may be selected from the group consisting of cationic, anionic, zwitterionic, amphoteric, nonionicand combinations thereof. Some non-limiting examples are those cited in U.S. Pat. No. 6,435,277 (Qu et al.) and U.S. Pat. No. 6,703,352 (Dahayanake et al.), each of which are incorporated herein by reference in their entirety. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactants of the family of betaine is used.

Exemplary cationic viscoelastic surfactants include the amine salts and quaternary amine salts disclosed in U.S. Pat. Nos. 5,979,557, and 6,435,277 which are hereby incorporated by reference in their entirety. Examples of suitable cationic viscoelastic surfactants include cationic surfactants having the structure: R₁N₊(R₂)(R₃)(R₄) X⁻ inwhich R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated by reference in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula: R₁CON(R₂)CH₂X, wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

Friction reducers may also be incorporated in any fluid embodiment. Any suitable friction reducer polymer, such as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing the use of conventional fluid loss additives. Latex resins or polymer emulsions may be incorporated as fluid loss additives. Shear recovery agents may also be used in embodiments.

Diverting agents may be added to improve penetration of the unviscosified and/or viscosified fluids into lower-permeability areas when treating a zone with heterogeneous permeability.

The viscosified fluid for treating a subterranean formation of the present disclosure may be a fluid that has a viscosity of above about 50 centipoise at 100 sec⁻¹, such as a viscosity of above about 100 centipoise at 100 sec⁻¹ at the treating temperature, which may range from about 79.4° C. (175° F.) to about 232.2° C. (450° F.), such as from about 79.4° C. (175° F.) to about 204.4° C. (400° F.), such as from about 79.4° C. (175° F.) to about 176.7° C. (350° F.), such as from about 79.4° C. (175° F.) to about 148.8° C. (300° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.). In embodiments, the crosslinked structure formed that is acted upon by the aldehyde releasing compound may be a gel that is substantially non-rigid after substantial crosslinking. In some embodiments, a crosslinked structure that is acted upon by the aldehyde releasing compound is a non-rigid gel. Non-rigidity can be determined by any techniques known to those of ordinary skill in the art. The storage modulus G′ of substantially crosslinked fluid system of the present disclosure, as measured according to standard protocols given in U.S. Pat. No. 6,011,075, the disclosure of which is hereby incorporated by reference in its entirety, may be about 150 dynes/cm² to about 500,000 dynes/cm², such as from about 1000 dynes/cm² to about 200,000 dynes/cm², or from about 10,000 dynes/cm² to about 150,000 dynes/cm².

The methods of the present disclosure may also employ an additional material as a breaker in addition to the aldehyde releasing compound described above. In this regard, conventional oxidizers, enzymes, or acids may be used. Such breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker, the borate anion, reversibly create the borate crosslinks. Lowering the pH can just as easily remove the borate/polymer bonds. At a high pH above 8, the borate ion exists and is available to crosslink and cause gelling. At lower pH, the borate is tied up by hydrogen and is not available for crosslinking, thus gelation by borate ion is reversible.

Embodiments may also include proppant particles that are substantially insoluble in the fluids of the formation. Proppant particles carried by the unviscosified and/or viscosified fluids remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it may be from about 20 to about 100 U.S. Standard Mesh in size. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particulation, processing, etc. Further information on nuts and composition thereof may be found in ENCYCLOPEDIA OF CHEMICAL TECHNOLOGY, Edited by Raymond E. Kirk and Donald F. Othmer, Third Edition, John Wiley & Sons, vol. 16, pp. 248-273, (1981).

The concentration of proppant in the unviscosified and/or viscosified can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

A fiber component may be included in the unviscosified and/or viscosified to achieve a variety of properties including improving particle suspension, and particle transport capabilities, and gas phase stability. Fibers used may be hydrophilic or hydrophobic in nature. Fibers can be any fibrous material, such as natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Suitable fibers may include polyester fibers coated to be highly hydrophilic, such as, but not limited to, polyethylene terephthalate (PET) fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in the unviscosified and/or viscosified fluids, the fiber component may be included at concentrations from about 1 to about 15 grams per liter of the liquid phase of the fluid, such as a concentration of fibers from about 2 to about 12 grams per liter of liquid, or from about 2 to about 10 grams per liter of liquid.

Embodiments may further use unviscosified and/or viscosified fluids containing other additives and chemicals that are known to be commonly used in oilfield applications by those skilled in the art. These include materials such as surfactants in addition to those mentioned hereinabove, breaker activators (breaker aids) in addition to those mentioned hereinabove, oxygen scavengers, alcohol stabilizers, scale inhibitors, corrosion inhibitors, fluid-loss additives, bactericides and additional biocides (besides the aldehyde releasing compound described above) such as 2,2-dibromo-3-nitrilopropionamine or glutaraldehyde, and the like. Also, they may include a co-surfactant to optimize viscosity or to minimize the formation of stable emulsions that contain components of crude oil.

The foregoing may be better understood by reference to the following examples, which are presented for purposes of illustration and are not intended to limit the scope of the present disclosure

In order to exemplify the embodiments two types of crosslinked fracturing fluids were prepared. Delayed borate crosslinked fluids and delayed zirconate crosslinked fluids were prepared. The fluid preparation was performed according to the following generic lab protocols:

For both borate and zirconate crosslinked fluids, the first step in the fluid formulation was to prepare an aqueous solution of the selected polymer gelling agent at the required concentration. In all examples, a linear fluid comprising polymer, water, clay stabilizer, surfactant, biocide when required, and thermal stabilizer was mixed using an overhead mixer, and subsequently used to formulate the crosslinked fluid if appropriate. In a first instance, the clay stabilizer was dissolved in fresh water using an overhead mixer and mix for 5 minutes. The required concentration of biocide was mixed for 1 additional minute. A thermal stabilizer was subsequently added to the water solution and mixed for 10 minutes until it fully dissolved. Additionally, a nonionic surfactant mixture was added to the solution and mixed for 5 minutes when required. When required a hydration buffer was added to the solution and mixed for 1 minute. Finally the required slurried polymer concentration was added to the aqueous solution and mixed using the overhead mixer to ensure full hydration. After 30 minutes the pH and viscosity of the prepared polymer solution (which in the foregoing will be called linear fluid) was measured at room temperature and compared to the reference

Delayed borate crosslinked fluids were mixed using an overhead mixer, and brought to a Chandler 5550 rheometer following preparation. The required linear fluid volume was measured in a beaker. The required volume of boron containing crosslinker-activator solution was added into to the linear fluid. The required volume of an aqueous breaker solution was added to the fluid when required.

Delayed zirconate crosslinked fluids were mixed using a Waring Blender, and brought to a Chandler 5550 rheometer following preparation. The linear fluid volume was measured in a graduated cylinder, and the volume of the zirconium containing crosslinker solution and the required concentration of the pH activator was added into to the linear fluid using micro-pipettes. The required volume of an aqueous breaker solution was added to the fluid when required.

### EXAMPLE 1

### Delayed Zirconate Crosslinked Fluid at 121° C. [250° F.]

Linear fluids were prepared according to the protocol described above using additives and concentrations in Table 2. For the preparation tap water was used, potassium chloride was used as clay stabilizer, Sodium diacetate as acid buffer. When required (ethylenedioxy)dimethanol one of the example multifunctional additives discussed in greater detail above—that can work as biocide and fluid breaker—was added to the linear fluid. (Ethylenedioxy)dimethanol can be commercially sourced as ‘Bodoxin AE’ by Ashland. A proprietary slurried carboxymethyl hydroxypropyl guar (CMHPG) polymer formulation was used to deliver the required polymer gelling agent concentration. The slurried CMHPG formulation comprised guar gum double derivative and 2-Butoxyethanol. The details for the composition of Example 1 are described below in Table 2.

TABLE 2
Linear Fluid Formulation

| Additive | Concentration | | Amount | |
|---|---|---|---|---|
| Tap Water | 1.00 | m³/m³ | 200 | mL |
| Potassium Chloride | 20.00 | kg/m³ | 4.00 | g |
| Sodium diacetate | 0.5 | L/m³ | 0.10 | mL |
| Multifunctional Additive Biocide-Breaker: | Per example | | As needed | |
| (Ethylenedioxy)dimethanol | in Table 5 | | | |
| CMHPG Polymer Slurry (0.36% 30 ppt) | 8.00 | L/m³ | 1.60 | mL |

In order to prepare the crosslinked fluids of this example a tailored crosslinker-activator formulation in Table 3 was added in the liner fluid with the help of a Waring blender and mixed for 5 minutes to ensure full dissolution of solids. The crosslinking formulation was prepared with the tetraethylenepentamine as high temperature fluid stabilizer and a proprietary blend of zirconate.

TABLE 3
Crosslinking additives Formulation

| Additive | Concentration | | Amount |
|---|---|---|---|
| Tetraethylenepentamine | 1.00 | mL/m³ | 1.00 ml |
| Proprietary Zirconate Crosslinker | 1.00 | L/m³ | 1.00 ml |

Delayed zirconate crosslinked fluids were prepared according to the Table 4.

TABLE 4
Delayed Crosslinked Fluid Formulation

| Additive | Concentration | | Amount | |
|---|---|---|---|---|
| Linear Fluid | 1.00 | m³/m³ | 200 | ml |
| Tetraethylenepentamine | 1.00 | L/m³ | 0.20 | ml |
| Proprietary Zirconate Crosslinker | 1.00 | L/m³ | 0.20 | ml |

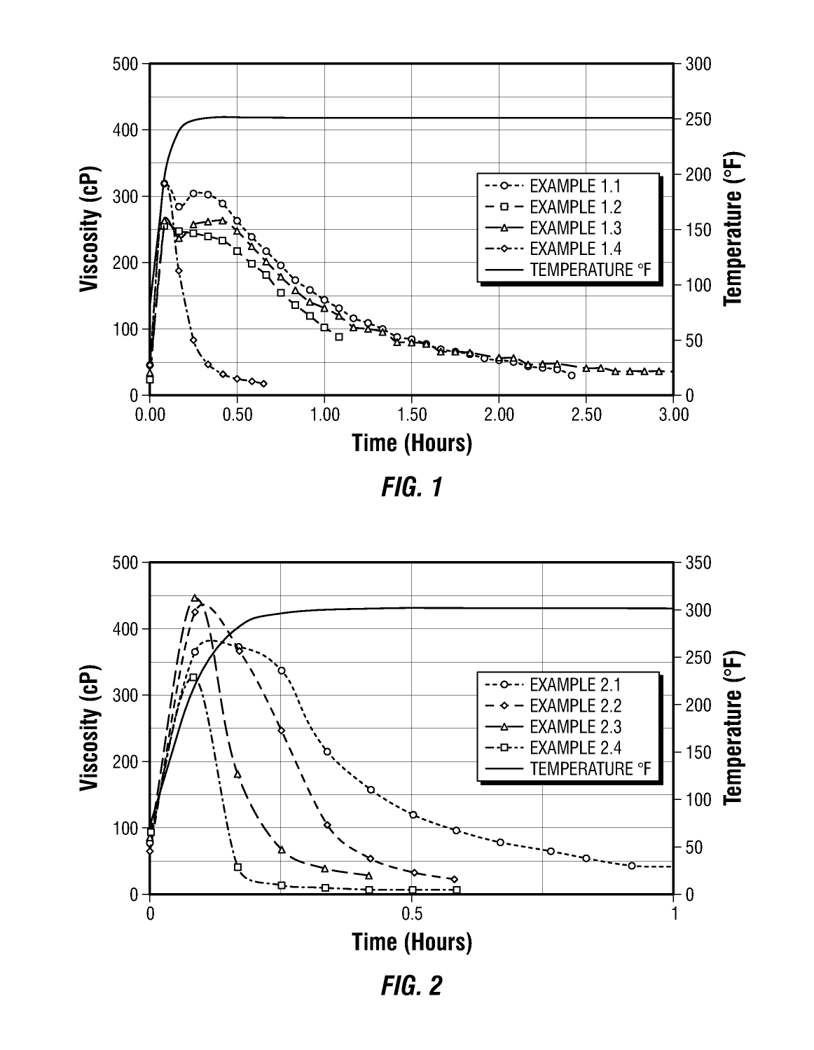

The linear fluids were prepared with and without multifunctional additive biocide-breaker and the crosslinked fluids were tested for their rheological performance. The crosslinked fluids were prepared with linear fluid and crosslinking formulation. The tested fluids in the example were formulated as shown in Table 5. The rheology curves of these Examples are illustrated in FIG. 1.

TABLE 5
Zirconate Crosslinked Fluids Examples

| | | | Multifunctional |
|---|---|---|---|
| | | | Additive |
| | | Crosslinking | Biocide- |
| Fluid ID | Linear Fuid | Formulation | Breaker |
| Example 1.1 | 1.00 m³/m³ | 2.00 L/m³ | No |
| Example 1.2 | 1.00 m³/m³ | 2.00 L/m³ | 0.25 L/m³ |
| Example 1.3 | 1.00 m³/m³ | 2.00 L/m³ | 0.50 L/m³ |
| Example 1.4 | 1.00 m³/m³ | 2.00 L/m³ | 1.00 L/m³ |

The plot (FIG. 1) illustrates that at moderately high temperatures such as 121° C. one particular environmentally friendly aldehyde releasing multifunctional additive example that can function as biocide at low temperature and as breaker at high temperature (Bodoxin AE) exhibits a controllable break in a zirconate crosslinked fracturing fluid, at concentrations between 0.25 and 0.5 L/m³ and more extensive breaking at concentrations around 1.0 L/m³.

### EXAMPLE 2

### Delayed Zirconate Crosslinked Fluid at 149° C. [300° F.]

Linear fluids were prepared according to the protocol described above using additives and concentrations in Table 6. For the preparation tap water was used, potassium chloride was used as clay stabilizer, Sodium diacetate as acid buffer. When required (ethylenedioxy)dimethanol, a multifunctional additive that can work as biocide and fluid breaker, was added to the linear fluid. (Ethylenedioxy)dimethanol can be commercially sourced as ‘Bodoxin AE’ by Ashland. A proprietary slurried carboxymethyl hydroxypropyl guar (CMHPG) polymer formulation was used to deliver the required polymer gelling agent concentration. The slurried CMHPG formulation comprised guar gum double derivative and 2-butoxyethanol.

TABLE 6
Linear Fluid Formulation

| Additive | Concentration | | Amount | |
|---|---|---|---|---|
| Tap Water | 1.00 | m³/m³ | 200 | m1 |
| Potassium Chloride | 20.00 | kg/m³ | 4.00 | g |
| Sodium diacetate | 0.50 | L/m³ | 0.10 | ml |
| Proprietary Surfactant blend | 2.00 | L/m³ | 2.00 | ml |
| Multifunctional Additive Biocide-Breaker: | Per example | | As | |
| (Ethylenedioxy)dimethanol | in Table 9 | | needed | |
| CMHPG Polymer Slurry (Polymer 0.48% | 10.60 | L/m³ | 2.13 | ml |
| 40 ppt) | | | | |

In order to prepare the crosslinked fluids of this example a tailored crosslinker-activator formulation in Table 7 was added in the liner fluid with the help of a waring blender and mixed for 5 minutes to ensure full dissolution of solids. The crosslinking formulation was prepared with the tetraethylenepentamine as high temperature fluid stabilizer and a proprietary blend of zirconate.

TABLE 7
Crosslinking Formulation

| Additive | Concentration | Amount |
|---|---|---|
| Tetraethylenepentamine | 1.00 L/m³ | 1.00 ml |
| Proprietary Zirconate Crosslinker | 1.20 L/m³ | 1.20 ml |

Delayed zirconate crosslinked fluids were prepared according to the Table 8.

TABLE 8
Delayed Crosslinked Fluid Formulation

| Additive | Concentration | Amount |
|---|---|---|
| Linear Fluid | 1.00 m³/m³ | 200 ml |
| Tetraethylenepentamine | 1.00 L/m³ | 0.20 ml |
| Proprietary Zirconate Crosslinker | 1.20 L/m³ | 0.24 ml |

The linear fluids were prepared according to the protocol described above using additives and concentrations. The crosslinked fluids were prepared with linear fluid and crosslinking formulation. The crosslinked fluids were prepared with and without multifunctional additive biocide-breaker and tested for their rheological performance. The tested fluids in the example were formulated as shown in Table 9. The rheology curves of these Examples are illustrated in FIG. 2.

TABLE 9
Zirconate Crosslinked Fluids Examples

| | | | Multifunctional |
|---|---|---|---|
| | | | Additive |
| | | Crosslinking | Biocide- |
| Fluid ID | Linear Fuid | Formulation | Breaker |
| Example 2.1 | 1.00 m³/m³ | 2.20 L/m³ | No |
| Example 2.2 | 1.00 m³/m³ | 2.20 L/m³ | 0.25 L/m³ |
| Example 2.3 | 1.00 m³/m³ | 2.20 L/m³ | 0.50 L/m³ |
| Example 2.4 | 1.00 m³/m³ | 2.20 L/m³ | 1.00 L/m³ |

The plot (FIG. 2) shows that at high temperatures such as 149° C. one particular environmentally friendly aldehyde releasing multifunctional additive example that can function as biocide at low temperature and as breaker at high temperature (Bodoxin AE) exhibits a controllable break at concentrations between 0.25 and 1.0 L/m³ for a zirconate crosslinked fracturing fluid.

### EXAMPLE 3

### Delayed Borate Crosslinked Fluid at 124° C. [255° F.]

Linear fluids were prepared according to the protocol described above using additives and concentrations in Table 10. For the preparation tap water was used, potassium chloride was used as clay stabilizer, sodium thiosulfate pentahydrate was used as high temperature stabilizer. A proprietary surfactant blend comprising Isopropanol, 2-Butoxyethanol, water and various linear and branched ethoxylated alcohols was used. When required (ethylenedioxy)dimethanol, a multifunctional additive that can work as biocide and fluid breaker, was added to the linear fluid. (Ethylenedioxy)dimethanol can be commercially sourced as ‘Bodoxin AE’ by Ashland. A proprietary slurried guar polymer formulation was used to deliver the required polymer gelling agent concentration. Said slurried guar formulation comprised guar gum and 2-Butoxyethanol

TABLE 10
Linear Fluid Formulation

| Additive | Concentration | Amount |
|---|---|---|
| Tap Water | 1.00 m³/m³ | 200 ml |
| Potassium Chloride | 20.00 kg/m³ | 4.00 g |
| Proprietary Non ionic surfactant blend | 2.00 L/m³ | 0.40 ml |
| Nonionic-cationic surfactant blend | 2.00 L/m³ | 0.40 ml |
| Multifunctional Additive Biocide-Breaker: | Per example | As |
| (Ethylenedioxy)dimethanol | in Table 12 | needed |
| Guar Polymer Slurry (Polymer 0.42% 35 ppt) | 10.70 L/m³ | 2.15 ml |

In order to prepare the crosslinked fluids of this example a tailored crosslinker-activator aqueous solution was prepared in a beaker and mixed by means of a magnetic bar, according to the formulation in Table 11 for 1 hour to ensure all solids were fully dissolved.

TABLE 11
Crosslinker-activator Solution

| Additive | Concentration | Amount |
|---|---|---|
| Tap Water | 4.60 L/m³ | 4.60 ml |
| Sodium Hydroxide Solution (30%) | 2.25 L/m³ | 2.25 ml |
| Sodium Hydroxide Pellets | 0.36 kg/m³ | 0.36 g |
| Boric Acid | 0.60 kg/m³ | 0.60 g |
| Sodium Gluconate | 1.80 kg/m³ | 1.80 g |
| 2,2′,2″-Nitrilotriethanol | 1.00 L/m³ | 1.00 ml |

Delayed borate crosslinked fluids were prepared according to the Table 12.

TABLE 12
Delayed Crosslinked Fluid Formulation

| Additive | Concentration | Amount |
|---|---|---|
| Linear Fluid | 1.00 m³/m³ | 200 ml |
| Crosslinker-activator Solution | 9.2 L/m³ | 1.84 ml |
| Breaker | As Needed | As Needed |

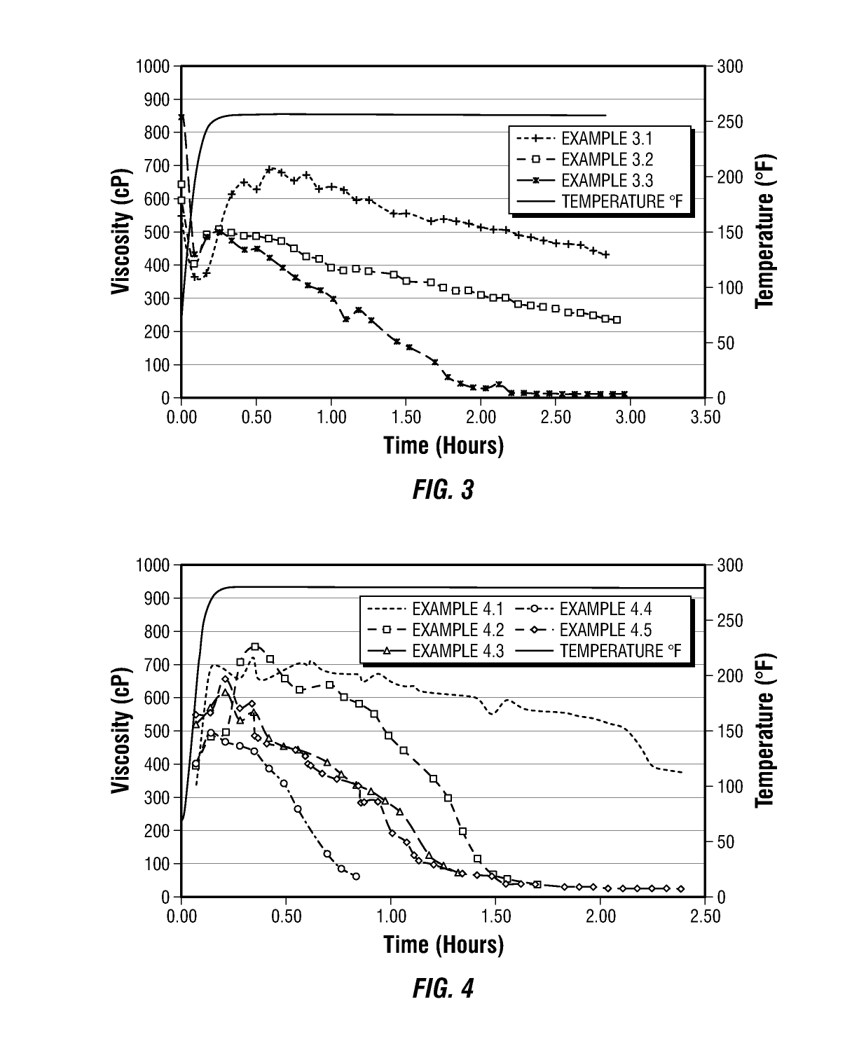

The crosslinked fluids were prepared with linear fluid and crosslinker. The fluids were prepared with and without Additive Biocide-Breaker and breaker and tested for their rheological performance. The tested fluids in the example were formulated as shown in Table 13. The rheology curves of these Examples are illustrated in FIG. 3.

TABLE 13
Borate Crosslinked Fluids Examples

| | | Crosslinker- | Additive | Breaker |
|---|---|---|---|---|
| | | activator | Biocide- | Sodium |
| Fluid ID | Linear Fluid | solution | Breaker | Bromate |
| Example 3.1 | 0.99 m³/m³ | 9.2 L/m³ | No | 0.35 kg/m³ |
| Example 3.2 | 0.99 m³/m³ | 9.2 L/m³ | 0.25 L/m³ | 0.35 kg/m³ |
| Example 3.3 | 0.99 m³/m³ | 9.2 L/m³ | 1.00 L/m³ | 0.35 kg/m³ |

FIG. 3 shows that at moderately high temperatures such as 124° C. one particular environmentally friendly aldehyde releasing multifunctional additive example that can function as biocide at low temperature and as breaker at high temperature (Bodoxin AE) exhibits a controllable break at concentrations between 0.25 and 1.0 L/m3 for4 a borate crosslinked fracturing fluid.

### EXAMPLE 4

### Delayed Borate Crosslinked Fluid at 137° C. [280° F.]

A linear fluid was prepared according to the protocol described above using additives and concentrations in Table 14. For the preparation tap water was used, potassium chloride was used as clay stabilizer, sodium thiosulfate pentahydrate was used as high temperature stabilizer. A proprietary surfactant blend comprising isopropanol, 2-butoxyethanol, water and various linear and branched ethoxylated alcohols was used. When required (ethylenedioxy)dimethanol, a multifunctional additive that can work as biocide and fluid breaker, was added to the linear fluid. A proprietary slurried guar polymer formulation was used to deliver the required polymer gelling agent concentration. The slurried guar formulation comprised Guar gum and 2-Butoxyethanol.

TABLE 14
Linear Fluid Formulation

| Additive | Concentration | Amount |
|---|---|---|
| Tap Water | 1.00 m³/m³ | 200 ml |
| Potassium Chloride | 20.00 kg/m³ | 4.00 g |
| Proprietary Non ionic surfactant blend | 2.00 L/m³ | 0.40 ml |
| Nonionic-cationic surfactant blend | 2.00 L/m³ | 0.40 ml |
| Multifunctional Additive Biocide-Breaker: | Per example | As |
| (Ethylenedioxy)dimethanol | in Table 17 | needed |
| Guar Polymer Slurry (Polymer 0.48% 40 ppt) | 12.20 L/m³ | 2.44 ml |

A linear fluid was prepared according to the protocol described above using additives and concentration. In order to prepare the crosslinked fluids of this example a tailored crosslinker-activator aqueous solution was prepared in a beaker and mixed by means of a magnetic bar, according to the formulation in Table 15 for 1 hour to ensure all solids were fully dissolved.

TABLE 15
Crosslinker Solution

| Additive | Concentration | Amount |
|---|---|---|
| Tap Water | 4.60 L/m3 | 4.60 ml |
| Sodium Hydroxide Solution (30%) | 2.25 L/m3 | 2.25 ml |
| Sodium Hydroxide | 0.36 kg/m3 | 0.36 g |
| Boric Acid | 0.70 kg/m3 | 0.70 g |
| Sodium Gluconate | 1.80 kg/m3 | 1.80 g |
| 2,2′,2″-Nitrilotriethanol | 1.00 L/m3 | 1.00 ml |

Delayed borate crosslinked fluids were prepared according to the Table 16.

TABLE 16
Delayed Crosslinked Fluid Formulation

| Additive | Concentration | Amount |
|---|---|---|
| Linear Fluid | 1.00 m³/m³ | 200 ml |
| Crosslinker Solution | 9.6 L/m³ | 1.92 ml |
| Breaker | As Needed | As Needed |

The crosslinked fluids were prepared with linear fluid and crosslinker. The fluids were prepared with and without biocide and breaker and tested for their rheological performance. The tested fluids in the example were formulated as shown in Table 17. The rheology curves of these Examples are illustrated in FIG. 4.

TABLE 17
Borate Crosslinked Fluids Examples

| | | Crosslinker- | Additive | Breaker |
|---|---|---|---|---|
| | | activator | Biocide- | Sodium |
| Fluid ID | Linear Fluid | solution | Breaker | Bromate |
| Example 4.1 | 0.99 m³/m³ | 9.6 L/m³ | No | No |
| Example 4.2 | 0.99 m³/m³ | 9.6 L/m³ | No | 0.60 kg/m³ |
| Example 4.3 | 0.99 m³/m³ | 9.6 L/m³ | 0.25 L/m³ | 0.60 kg/m³ |
| Example 4.4 | 0.99 m³/m³ | 9.6 L/m³ | 1.00 L/m³ | 0.60 kg/m³ |
| Example 4.5 | 1.00 m³/m³ | 9.6 L/m³ | 0.25 L/m³ | No |

The plot (FIG. 4) shows that at moderately high temperatures such as 137° C. one particular environmentally friendly aldehyde releasing multifunctional additive example that can function as biocide at low temperature and as breaker at high temperature (Bodoxin AE) exhibits a controllable break at a concentrations of 0.25 L/m³ for a borate crosslinked fracturing fluid. The plot also shows that the environmentally friendly aldehyde releasing multifunctional additive example that can function as biocide at low temperature and as breaker at high temperature (Bodoxin AE) can still remain active as a strong breaker in the presence of other oxidative breakers such as sodium bromate in a borate crosslinked fracturing fluid. Finally the plot also shows that for a borate crosslinked fracturing fluid, the environmentally friendly aldehyde releasing multifunctional additive example that can function as biocide at low temperature and as breaker at high temperature (Bodoxin AE), acts as an stronger breaker than the common sodium bromate, when compared on a weight by weight basis.

### EXAMPLE 5

### Delayed Zirconate Crosslinked Fluid at 210° C. [410° F.]

Linear fluids were prepared according to the protocol described above using additives and concentrations in Table 2. For the preparation tap water was used, choline chloride was used as clay stabilizer, and a non ionic surfactant was added to the mix water. When required (ethylenedioxy)dimethanol, one example of the multifunctional additives discussed in greater detail above—that can work as biocide and fluid breaker—was added to the linear fluid. (Ethylenedioxy)dimethanol can be commercially sourced as ‘Bodoxin AE’ by Ashland. A proprietary synthetic emulsion of a polyacrylamide derivative polymer was used to deliver the required polymer gelling agent concentration. The details for the composition of Example 5 are described below in Table 20.

TABLE 18
Linear Fluid Formulation

| Additive | Concentration | Amount |
|---|---|---|
| Tap Water | 1.00 m³/m³ | 250 mL |
| Choline Chloride | 2.00 L/m³ | 0.50 ml |
| Non Ionic surfactant | 2.00 L/m³ | 0.50 mL |
| Multifunctional Additive Biocide-Breaker: | Per example | As needed |
| (Ethylenedioxy)dimethanol | in Table 21 | |
| Synthetic polymer emulsion (Polymer | 20.00 L/m³ | 5.00 mL |
| 0.54% 45 ppt) | | |

In order to prepare the crosslinked fluids of this example a tailored crosslinker-activator formulation in Table 3 was added in the linear fluid with the help of a Waring blender and mixed for 2 minutes to ensure full dissolution of solids. The crosslinking formulation was prepared with the sodium thiosulfate pentahydrate as high temperature fluid stabilizer and a proprietary blend of zirconate.

TABLE 19
Crosslinking additives Formulation

| Additive | Concentration | Amount |
|---|---|---|
| Sodium Thiosulfate pentahydrate | 1.00 mL/m³ | 1.00 ml |
| Proprietary Zirconate Crosslinker | 4.000 L/m³ | 1.00 ml |

Delayed zirconate crosslinked fluids were prepared according to the Table 4.

TABLE 20
Delayed Crosslinked Fluid Formulation

| Additive | Concentration | Amount |
|---|---|---|
| Linear Fluid | 1.00 m³/m³ | 250 ml |
| Sodium Thiosulfate pentahydrate | 0.111 Kg/m³ | 0.028 g |
| Proprietary Zirconate Crosslinker | 4.00 L/m³ | 1.00 ml |

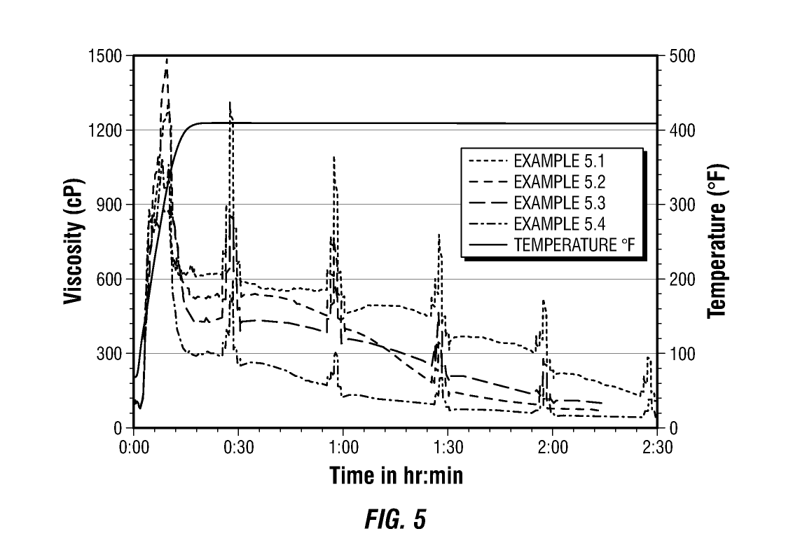

The linear fluids were prepared with and without multifunctional additive biocide-breaker and the crosslinked fluids were tested for their rheological performance. The crosslinked fluids were prepared with linear fluid and crosslinking formulation. The tested fluids in the example were formulated as shown in Table 5. The rheology curves of these Examples are illustrated in FIG. 5. When required for comparison a common high temperature oxidizer, sodium bromate was included in the formulation.

TABLE 21
Zirconate Crosslinked Fluids Examples

| | | | Multifunctional | |
|---|---|---|---|---|
| | | | Additive | Breaker |
| | | Crosslinking | Biocide- | Sodium |
| Fluid ID | Linear Fuid | Formulation | Breaker | Bromate |
| Example 5.1 | 1.00 m³/m³ | 4.00 L/m³ | No | No |
| Example 5.2 | 1.00 m³/m³ | 4.00 L/m³ | 0.50 L/m³ | No |
| Example 5.3 | 1.00 m³/m³ | 4.00 L/m³ | 1.00 L/m³ | No |
| Example 5.4 | 1.00 m³/m³ | 4.00 L/m³ | No | 0.066 Kg/m³ |

The plot (FIG. 5) shows that at very high temperatures such as 210° C. one particular environmentally friendly aldehyde releasing multifunctional additive example (Bodoxin AE) can function as biocide at low temperature and as breaker at high temperature. A zirconate crosslinked synthetic polymer based high temperature fracturing fluid formulated with Bodoxin AE exhibits a controllable break at a concentrations of 0.5 L/m³ or 1 1/m³, which is comparable to a sodium bromate breaker.

### EXAMPLE 6

### Bacteria Growth Study at 35° C. [95° F.]

Following is the qualitative study of bacteria growth in water using dipslides. A dipslide is used to test the presence of microorganisms in liquids. Dipslides are the fastest and easiest way to measure the microbial activity in liquid-based systems and in this testing it is used to evaluate the performance of Bodoxin AE. It can be seen that location water has a tendency to form bacteria and that when biocide is used, the bacteria count is reduced significantly reaching the same level as tap or distilled water. The data as shown in Table 22 demonstrates the effectiveness of Bodoxin AE as a biocide.

Table 21
Biocide effectiveness Examples

| | Biocide Conc. | Bacteria count | |
|---|---|---|---|
| Additive | (gpt) | Two replicated tests | |
| North Sea Location | 0.00 | 10³ (CFU/ml) | 10³ (CFU/ml) |
| Water | | | |
| (no biocide) | | | |
| UK Tap Water | 0.00 | <10³ (CFU/ml) | <10³ (CFU/ml) |
| (no biocide) | | | |
| Distilled Water | 0.00 | <10³ (CFU/ml) | <10³ (CFU/ml) |
| (no biocide) | | | |
| North Sea Location | 0.50 | <10³ (CFU/ml) | <10³ (CFU/ml) |
| Water with | 1.00 | <10³ (CFU/ml) | <10³ (CFU/ml) |
| Biocide (Bodoxin AE) | 1.50 | <10³ (CFU/ml) | <10³ (CFU/ml) |

Although only a few example embodiments have been described in detail above, those skilled in the art will readily appreciate that many modifications are possible in the example embodiments without materially departing from ENVIRONMENTALLY ACCEPTABLE MULTIFUNCTIONAL ADDITIVE. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method of treating a subterranean formation penetrated by a wellbore, the method comprising:
introducing a treatment fluid comprising an aqueous fluid composition comprising an aldehyde releasing compound,
wherein the aldehyde releasing compound:
reduces a plurality of bacteria in the treatment fluid to be less than 1×10³ colony-forming units (CFU) at a temperature range of from about −10° C. to about 60° C. and
reduces the viscosity of a viscosified treatment fluid by at least one order of magnitude while the viscosified treatment fluid is at a temperature in the range of from about 79.4° C. (175° F.) to about 232.2° C. (450° F.).

2. The method of claim 1, wherein the aqueous fluid composition comprises a crosslinked polymer based fracturing fluid.

3. The method of claim 1, wherein the aqueous fluid composition comprises a viscoelastic surfactant based fracturing fluid.

4. The method of claim 1, wherein the aldehyde releasing compound reduces the viscosity of the viscosified treatment fluid by at least two orders of magnitude while the viscosified treatment fluid is at a temperature in the range of from about 79.4° C. (175° F.) to about 232.2° C. (450° F.).

5. The method of claim 1, wherein the aldehyde releasing compound is described by the following molecular structure 1A 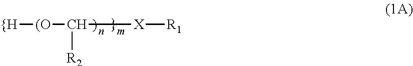
where:
R₁ is a functional hydrocarbon comprising one or more of carbon (C), hydrogen (H), nitrogen (N) oxygen (O) chlorine (Cl), bromine (Br), phosphorous (P), sulfur (S), fluorine (F) or combinations thereof, or which is linked to a (poly)acetal;
R₂ is hydrogen or an aliphatic or aromatic hydrocarbon structure;
n is an integer equal or higher than 1;
X is a heteroatom containing linking structure comprising —NH—, —N< or —O—; and
m is an integer of value of 1 unless —X is —N<, in which case m is an integer having a value of 2.

6. The method of claim 5, wherein the aldehyde releasing compound is described by the following molecular structure 1B 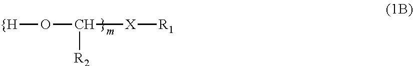
where:
R₁ is a functional hydrocarbon comprising one or more of carbon (C), hydrogen (H), nitrogen (N) oxygen (O) chlorine (Cl), bromine (Br), phosphorous (P), sulfur (S), fluorine (F) or combinations thereof, or which is linked to a (poly)acetal;
R₂ is hydrogen or an aliphatic or aromatic hydrocarbon structure;
X is a heteroatom containing linking structure comprising —NH—, —N< or —O—; and
m is an integer of value of 1 unless —X is —N<, in which case m is an integer having a value of 2.

7. The method of claim 1, wherein the aldehyde releasing compound is (ethylenedioxy)dimethanol.

8. The method of claim 1, wherein the aqueous fluid composition further comprises a crosslinking agent selected from the group consisting of boron, aluminum, antimony, zirconium, titanium and chromium.

9. The method of claim 8, wherein the crosslinking agent is boron.

10. The method of claim 8, wherein the aqueous fluid composition further comprises a polysaccharide crosslinkable component.

11. The method of claim 10, wherein the polysaccharide crosslinkable component is guar and the crosslinking agent is boron.

12. The method of claim 10, wherein the crosslinking agent is zirconium and the polysaccharide crosslinkable component is selected from the group consisting of guar, hydroxypropyl guar, carboxymethyl guar and carboxymethylhydroxypropyl guar.

13. The method of claim 8, wherein the aqueous fluid composition further comprises polyacrylamide, or polyacrylamide derivative.

14. The method of claim 13, wherein the crosslinking agent is a zirconium.

15. A method of treating a subterranean formation penetrated by a wellbore, the method comprising:
introducing a treatment fluid comprising an aqueous fluid composition comprising an aldehyde releasing compound,
wherein the aldehyde releasing compound:
reduces a plurality of bacteria in the treatment fluid to be less than 1×10³ colony-forming units (CFU) at a temperature range of from about −10° C. to about 60° C. and
reduces a viscosity of a viscosified treatment fluid by at least 80% based upon the initial viscosity of the viscosified treatment fluid, while the viscosified treatment fluid is at a temperature in the range of from about 79.4° C. (175° F.) to about 232.2° C. (450° F.).
